(19) United States
(12) Patent Application Publication
(10) Pub. No.: US 2015/0033751 A1
(43) Pub. Date: Feb. 5, 2015

(54) SYSTEM AND METHOD FOR A WATER INJECTION SYSTEM

(71) Applicants: General Electric Company, Schenectady, NY (US); ExxonMobil Upstream Research Company, Houston, TX (US)

(72) Inventor: Philip Lynn Andrew, Simpsonville, SC (US)

(21) Appl. No.: 14/314,575

(22) Filed: Jun. 25, 2014

Related U.S. Application Data
(60) Provisional application No. 61/860,830, filed on Jul. 31, 2013.

(51) Int. Cl. F02C 3/30; F02C 7/10; E21B 43/16; F01D 25/12; F02C 7/143; F02C 6/18; F01D 25/30

(52) U.S. Cl. CPC F02C 3/305; F02C 6/18; F02C 7/10; F01D 25/30; F01D 25/12; F02C 7/1435; E21B 43/16; F05D 2220/32; F05D 2260/212
USPC 60/775; 60/39.511; 60/39.5

(57) ABSTRACT

A system includes a compressor configured to compress a gaseous stream, an exhaust gas cooler configured to cool an exhaust gas from combustion with a cooling water, and a water injection system configured to inject the cooling water from the exhaust gas cooler into at least one of a compressor inlet of the compressor, a stage of the compressor, between stages of the compressor, or an inlet duct coupled to the compressor inlet of the compressor, or any combination thereof.

### CROSS-REFERENCE TO RELATED APPLICATIONS

This application claims priority to and benefit of U.S. Provisional Patent Application No. 61/860,830, entitled “SYSTEM AND METHOD FOR A WATER INJECTION SYSTEM,” filed on Jul. 31, 2013, which is hereby incorporated by reference in its entirety for all purposes.

### BACKGROUND

The subject matter disclosed herein relates to gas turbine engines, and more specifically, to systems and methods for a water injection system for gas turbine engines.

Gas turbine engines are used in a wide variety of applications, such as power generation, aircraft, and various machinery. Gas turbine engines generally combust a fuel with an oxidant (e.g., air) in a combustor section to generate hot combustion products, which then drive one or more turbine stages of a turbine section. In turn, the turbine section drives one or more compressor stages of a compressor section. Again, the fuel and oxidant mix in the combustor section, and then combust to produce the hot combustion products. At least one compressor section is used to compress the oxidant. Unfortunately, the compressor sections may operate inefficiently or may be susceptible to icing and/or surging under certain conditions. Furthermore, gas turbine engines typically consume a vast amount of air as the oxidant, and output a considerable amount of exhaust gas into the atmosphere. In other words, the exhaust gas is typically wasted as a byproduct of the gas turbine operation.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a compressor configured to compress a gaseous stream, an exhaust gas cooler configured to cool an exhaust gas from combustion with a cooling water, and a water injection system configured to inject the cooling water from the exhaust gas cooler into at least one of a compressor inlet of the compressor, a stage of the compressor, between stages of the compressor, or an inlet duct coupled to the compressor inlet of the compressor, or any combination thereof.

In a second embodiment, a system includes a controller that includes one or more tangible, non-transitory, machine-readable media collectively storing one or more sets of instructions and one or more processing devices configured to execute the one or more sets of instructions to compress a gaseous stream using a compressor, cool an exhaust gas from combustion with a cooling water using an exhaust gas cooler, and inject the cooling water from the exhaust gas cooler into at least one of a compressor inlet of the compressor, a stage of the compressor, between stages of the compressor, or an inlet duct coupled to the compressor inlet of the compressor, or any combination thereof using a water injection system.

In a third embodiment, a method includes compressing a gaseous stream using a compressor, cooling an exhaust gas from combustion with a cooling water using an exhaust gas cooler, and injecting the cooling water from the exhaust gas cooler into at least one of a compressor inlet of the compressor, a stage of the compressor, between stages of the compressor, or an inlet duct coupled to the compressor inlet of the compressor, or any combination thereof, using a water injection system.

In a fourth embodiment, a system includes a water supply system that includes at least one of a heat recovery steam generator (HRSG) configured to generate steam from an exhaust gas, an exhaust gas (EG) processing system configured to receive and process the exhaust gas, or a stoichiometric exhaust gas recirculation (SEGR) gas turbine system configured to stoichiometrically combust a fuel and an oxidant to generate the exhaust gas, or any combination thereof, and a water injection system configured to inject a cooling water from the water supply system into at least one of a compressor inlet of a compressor, a stage of the compressor, between stages of the compressor, or an inlet duct coupled to the compressor inlet of the compressor, or any combination thereof.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagram of an embodiment of a system having a turbine-based service system coupled to a hydrocarbon production system;

FIG. 2 is a diagram of an embodiment of the system of FIG. 1, further illustrating a control system and a combined cycle system;

FIG. 3 is a diagram of an embodiment of the system of FIGS. 1 and 2, further illustrating details of a gas turbine engine, exhaust gas supply system, and exhaust gas processing system;

FIG. 4 is a flow chart of an embodiment of a process for operating the system of FIGS. 1-3;

FIG. 5 is a schematic diagram of an embodiment of a gas turbine system with a water injection system;

FIG. 6 is a schematic diagram of an embodiment of an oxidant compressor system with a water injection system; and

FIG. 7 is a schematic diagram of an embodiment of an exhaust gas compressor system with a water injection system.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in an engineering or design project, numerous implementation-specific decisions are made to achieve the specific goals, such as compliance with system-related and/or business-related constraints, which may vary from one implementation to another. Moreover, it should be appreciated that such effort might be complex and time consuming, but would nevertheless be a routine undertaking of design, fabrication, and manufacture for those of ordinary skill having the benefit of this disclosure.

Detailed example embodiments are disclosed herein. However, specific structural and functional details disclosed herein are merely representative for purposes of describing example embodiments. Embodiments of the present invention may, however, be embodied in many alternate forms, and should not be construed as limited to only the embodiments set forth herein.

Accordingly, while example embodiments are capable of various modifications and alternative forms, embodiments thereof are illustrated by way of example in the figures and will herein be described in detail. It should be understood, however, that there is no intent to limit example embodiments to the particular forms disclosed, but to the contrary, example embodiments are to cover all modifications, equivalents, and alternatives falling within the scope of the present invention.

The terminology used herein is for describing particular embodiments only and is not intended to be limiting of example embodiments. As used herein, the singular forms “a”, “an” and “the” are intended to include the plural forms as well, unless the context clearly indicates otherwise. The terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Although the terms first, second, primary, secondary, etc. may be used herein to describe various elements, these elements should not be limited by these terms. These terms are only used to distinguish one element from another. For example, but not limiting to, a first element could be termed a second element, and, similarly, a second element could be termed a first element, without departing from the scope of example embodiments. As used herein, the term “and/or” includes any, and all, combinations of one or more of the associated listed items.

Certain terminology may be used herein for the convenience of the reader only and is not to be taken as a limitation on the scope of the invention. For example, words such as “upper”, “lower”, “left”, “right”, “front”, “rear”, “top”, “bottom”, “horizontal”, “vertical”, “upstream”, “downstream”, “fore”, “aft”, and the like; merely describe the configuration shown in the FIGS. Indeed, the element or elements of an embodiment of the present invention may be oriented in any direction and the terminology, therefore, should be understood as encompassing such variations unless specified otherwise.

As discussed in detail below, the disclosed embodiments relate generally to gas turbine systems with exhaust gas recirculation (EGR), and particularly stoichiometric operation of the gas turbine systems using EGR. For example, the gas turbine systems may be configured to recirculate the exhaust gas along an exhaust recirculation path, stoichiometrically combust fuel and oxidant along with at least some of the recirculated exhaust gas, and capture the exhaust gas for use in various target systems. The recirculation of the exhaust gas along with stoichiometric combustion may help to increase the concentration level of carbon dioxide (CO₂) in the exhaust gas, which can then be post treated to separate and purify the CO₂ and nitrogen (N₂) for use in various target systems. The gas turbine systems also may employ various exhaust gas processing (e.g., heat recovery, catalyst reactions, etc.) along the exhaust recirculation path, thereby increasing the concentration level of CO₂, reducing concentration levels of other emissions (e.g., carbon monoxide, nitrogen oxides, and unburnt hydrocarbons), and increasing energy recovery (e.g., with heat recovery units). Furthermore, the gas turbine engines may be configured to combust the fuel and oxidant with one or more diffusion flames (e.g., using diffusion fuel nozzles), premix flames (e.g., using premix fuel nozzles), or any combination thereof. In certain embodiments, the diffusion flames may help to maintain stability and operation within certain limits for stoichiometric combustion, which in turn helps to increase production of CO₂. For example, a gas turbine system operating with diffusion flames may enable a greater quantity of EGR, as compared to a gas turbine system operating with premix flames. In turn, the increased quantity of EGR helps to increase CO₂ production. Possible target systems include pipelines, storage tanks, carbon sequestration systems, and hydrocarbon production systems, such as enhanced oil recovery (EOR) systems.

The disclosed embodiments provide systems and methods for a water injection system used with a gas turbine engine with EGR. Specifically, the gas turbine engine may include at least one compressor that compresses a gaseous stream (e.g., exhaust gas or oxidant), an exhaust gas cooler that cools an exhaust gas with a cooling water, and a water injection system that injects the cooling water (e.g., liquid water, water vapor or steam, or a combination thereof) from the exhaust gas cooler into one or more locations associated with the compressor. For example, the compressor may be an oxidant compressor that compresses an oxidant (e.g., air, oxygen, or air-oxygen mixtures) to produce a compressed oxidant, or the compressor may be an exhaust gas compressor that compresses the exhaust gas to produce a compressed exhaust gas, or both. Examples of locations associated with the compressor where the water injection system may inject the cooling water include, but are limited to, one or more locations at a compressor inlet of the compressor, one or more locations at a stage (or stages) of the compressor, one or more locations between stages of the compressor, or one or more locations at an inlet duct coupled to the compressor inlet of the compressor, or any combination thereof. In certain embodiments, a water supply system may supply the cooling water to the water injection system. Examples of the water supply system include, but are not limited to, a heat recovery steam generator (HRSG) that generates steam from the exhaust gas, an exhaust gas (EG) processing system that receives and processes the exhaust gas, or a stoichiometric exhaust gas recirculation (SEGR) gas turbine system that stoichiometrically combusts a fuel and a oxidant to generate the exhaust gas, or any combination thereof.

By injecting the cooling water into the one or more locations associated with the compressor, the water injection system may improve operation of the compressor and the entire gas turbine system. For example, depending on where the cooling water is injected into the compressor, the water injection system may provide at least one of wet compression (e.g., injecting water at the compressor inlet such that the water evaporates during the compression process within the compressor), or inlet fogging (e.g., injecting water far upstream of the compressor inlet such that the water evaporates prior to ingestion by the compressor), or any combination thereof. As described in detail below, wet compression may decrease the power and/or work used to drive the compressor. Inlet fogging may increase a mass flow rate available to the compressor and/or increase an efficiency (e.g., compression per amount of input power to drive compressor) of the compressor. Inlet fogging may also decrease the power and/or work used to drive the compressor. In addition, either wet compression or inlet fogging may be used to maintain a difference between a shaft torque of the compressor and a shaft torque limit of the compressor within a desired range, which may help increase the efficiency of the compressor. Further, by using the cooling water from the exhaust gas cooler of the (SEGR) gas turbine system for injection into the compressor, the capital and/or operating costs associated with the gas turbine engine may be reduced because no dedicated water supply system is used with the water injection system. Instead, a water supply system already present in the gas turbine system may be used for water injection. Thus, by using the exhaust gas cooler to both cool exhaust gas and provide water to the water injection system, less energy is used by the SEGR gas turbine system, thereby reducing operating costs.

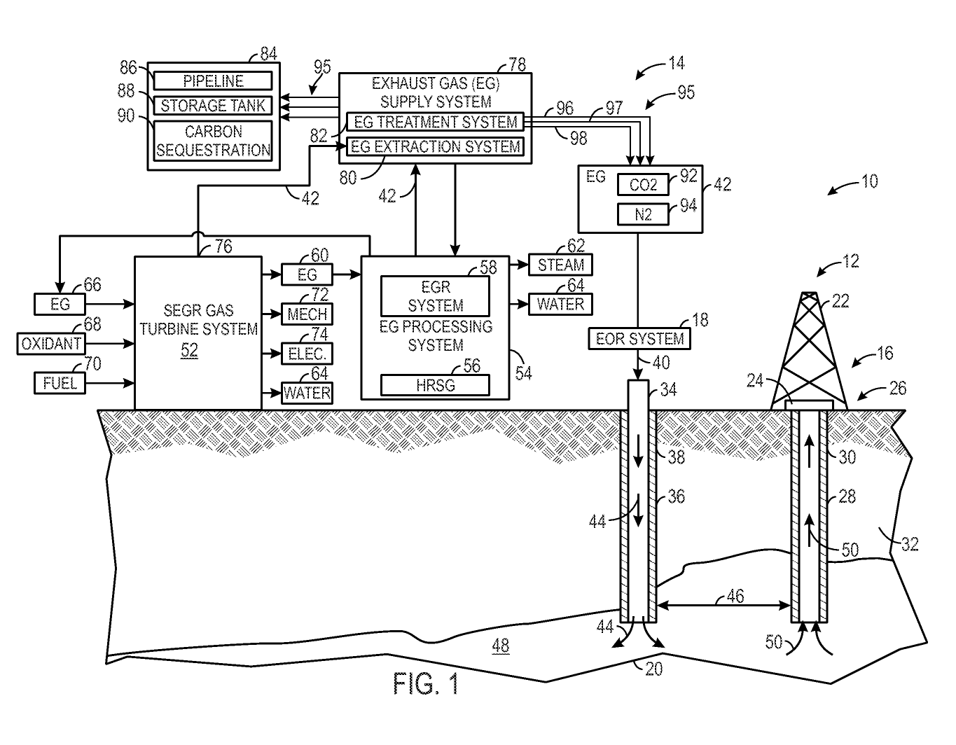

FIG. 1 is a diagram of an embodiment of a system 10 having an hydrocarbon production system 12 associated with a turbine-based service system 14. As discussed in further detail below, various embodiments of the turbine-based service system 14 are configured to provide various services, such as electrical power, mechanical power, and fluids (e.g., exhaust gas), to the hydrocarbon production system 12 to facilitate the production or retrieval of oil and/or gas. In the illustrated embodiment, the hydrocarbon production system 12 includes an oil/gas extraction system 16 and an enhanced oil recovery (EOR) system 18, which are coupled to a subterranean reservoir 20 (e.g., an oil, gas, or hydrocarbon reservoir). The oil/gas extraction system 16 includes a variety of surface equipment 22, such as a Christmas tree or production tree 24, coupled to an oil/gas well 26. Furthermore, the well 26 may include one or more tubulars 28 extending through a drilled bore 30 in the earth 32 to the subterranean reservoir 20. The tree 24 includes one or more valves, chokes, isolation sleeves, blowout preventers, and various flow control devices, which regulate pressures and control flows to and from the subterranean reservoir 20. While the tree 24 is generally used to control the flow of the production fluid (e.g., oil or gas) out of the subterranean reservoir 20, the EOR system 18 may increase the production of oil or gas by injecting one or more fluids into the subterranean reservoir 20.

Accordingly, the EOR system 18 may include a fluid injection system 34, which has one or more tubulars 36 extending through a bore 38 in the earth 32 to the subterranean reservoir 20. For example, the EOR system 18 may route one or more fluids 40, such as gas, steam, water, chemicals, or any combination thereof, into the fluid injection system 34. For example, as discussed in further detail below, the EOR system 18 may be coupled to the turbine-based service system 14, such that the system 14 routes an exhaust gas 42 (e.g., substantially or entirely free of oxygen) to the EOR system 18 for use as the injection fluid 40. The fluid injection system 34 routes the fluid 40 (e.g., the exhaust gas 42) through the one or more tubulars 36 into the subterranean reservoir 20, as indicated by arrows 44. The injection fluid 40 enters the subterranean reservoir 20 through the tubular 36 at an offset distance 46 away from the tubular 28 of the oil/gas well 26. Accordingly, the injection fluid 40 displaces the oil/gas 48 disposed in the subterranean reservoir 20, and drives the oil/gas 48 up through the one or more tubulars 28 of the hydrocarbon production system 12, as indicated by arrows 50. As discussed in further detail below, the injection fluid 40 may include the exhaust gas 42 originating from the turbine-based service system 14, which is able to generate the exhaust gas 42 on-site as needed by the hydrocarbon production system 12. In other words, the turbine-based system 14 may simultaneously generate one or more services (e.g., electrical power, mechanical power, steam, water (e.g., desalinated water), and exhaust gas (e.g., substantially free of oxygen)) for use by the hydrocarbon production system 12, thereby reducing or eliminating the reliance on external sources of such services.

In the illustrated embodiment, the turbine-based service system 14 includes a stoichiometric exhaust gas recirculation (SEGR) gas turbine system 52 and an exhaust gas (EG) processing system 54. The gas turbine system 52 may be configured to operate in a stoichiometric combustion mode of operation (e.g., a stoichiometric control mode) and a non-stoichiometric combustion mode of operation (e.g., a non-stoichiometric control mode), such as a fuel-lean control mode or a fuel-rich control mode. In the stoichiometric control mode, the combustion generally occurs in a substantially stoichiometric ratio of a fuel and oxidant, thereby resulting in substantially stoichiometric combustion. In particular, stoichiometric combustion generally involves consuming substantially all of the fuel and oxidant in the combustion reaction, such that the products of combustion are substantially or entirely free of unburnt fuel and oxidant. One measure of stoichiometric combustion is the equivalence ratio, or phi (φ), which is the ratio of the actual fuel/oxidant ratio relative to the stoichiometric fuel/oxidant ratio. An equivalence ratio of greater than 1.0 results in a fuel-rich combustion of the fuel and oxidant, whereas an equivalence ratio of less than 1.0 results in a fuel-lean combustion of the fuel and oxidant. In contrast, an equivalence ratio of 1.0 results in combustion that is neither fuel-rich nor fuel-lean, thereby substantially consuming all of the fuel and oxidant in the combustion reaction. In context of the disclosed embodiments, the term stoichiometric or substantially stoichiometric may refer to an equivalence ratio of approximately 0.95 to approximately 1.05. However, the disclosed embodiments may also include an equivalence ratio of 1.0 plus or minus 0.01, 0.02, 0.03, 0.04, 0.05, or more. Again, the stoichiometric combustion of fuel and oxidant in the turbine-based service system 14 may result in products of combustion or exhaust gas (e.g., 42) with substantially no unburnt fuel or oxidant remaining. For example, the exhaust gas 42 may have less than 1, 2, 3, 4, or 5 percent by volume of oxidant (e.g., oxygen), unburnt fuel or hydrocarbons (e.g., HCs), nitrogen oxides (e.g., NO_{X}), carbon monoxide (CO), sulfur oxides (e.g., SO_{X}), hydrogen, and other products of incomplete combustion. By further example, the exhaust gas 42 may have less than approximately 10, 20, 30, 40, 50, 60, 70, 80, 90, 100, 200, 300, 400, 500, 1000, 2000, 3000, 4000, or 5000 parts per million by volume (ppmv) of oxidant (e.g., oxygen), unburnt fuel or hydrocarbons (e.g., HCs), nitrogen oxides (e.g., NO_{X}), carbon monoxide (CO), sulfur oxides (e.g., SO_{X}), hydrogen, and other products of incomplete combustion. However, the disclosed embodiments also may produce other ranges of residual fuel, oxidant, and other emissions levels in the exhaust gas 42. As used herein, the terms emissions, emissions levels, and emissions targets may refer to concentration levels of certain products of combustion (e.g., NO_{X}, CO, SO_{X}, O₂, N₂, H₂, HCs, etc.), which may be present in recirculated gas streams, vented gas streams (e.g., exhausted into the atmosphere), and gas streams used in various target systems (e.g., the hydrocarbon production system 12).

Although the SEGR gas turbine system 52 and the EG processing system 54 may include a variety of components in different embodiments, the illustrated EG processing system 54 includes a heat recovery steam generator (HRSG) 56 and an exhaust gas recirculation (EGR) system 58, which receive and process an exhaust gas 60 originating from the SEGR gas turbine system 52. The HRSG 56 may include one or more heat exchangers, condensers, and various heat recovery equipment, which collectively function to transfer heat from the exhaust gas 60 to a stream of water, thereby generating steam 62. The steam 62 may be used in one or more steam turbines, the EOR system 18, or any other portion of the hydrocarbon production system 12. For example, the HRSG 56 may generate low pressure, medium pressure, and/or high pressure steam 62, which may be selectively applied to low, medium, and high pressure steam turbine stages, or different applications of the EOR system 18. In addition to the steam 62, a treated water 64, such as a desalinated water, may be generated by the HRSG 56, the EGR system 58, and/or another portion of the EG processing system 54 or the SEGR gas turbine system 52. The treated water 64 (e.g., desalinated water) may be particularly useful in areas with water shortages, such as inland or desert regions. The treated water 64 may be generated, at least in part, due to the large volume of air driving combustion of fuel within the SEGR gas turbine system 52. While the on-site generation of steam 62 and water 64 may be beneficial in many applications (including the hydrocarbon production system 12), the on-site generation of exhaust gas 42, 60 may be particularly beneficial for the EOR system 18, due to its low oxygen content, high pressure, and heat derived from the SEGR gas turbine system 52. Accordingly, the HRSG 56, the EGR system 58, and/or another portion of the EG processing system 54 may output or recirculate an exhaust gas 66 into the SEGR gas turbine system 52, while also routing the exhaust gas 42 to the EOR system 18 for use with the hydrocarbon production system 12. Likewise, the exhaust gas 42 may be extracted directly from the SEGR gas turbine system 52 (i.e., without passing through the EG processing system 54) for use in the EOR system 18 of the hydrocarbon production system 12.

The exhaust gas recirculation is handled by the EGR system 58 of the EG processing system 54. For example, the EGR system 58 includes one or more conduits, valves, blowers, exhaust gas treatment systems (e.g., filters, particulate removal units, gas separation units, gas purification units, heat exchangers, heat recovery units, moisture removal units, catalyst units, chemical injection units, or any combination thereof), and controls to recirculate the exhaust gas along an exhaust gas circulation path from an output (e.g., discharged exhaust gas 60) to an input (e.g., intake exhaust gas 66) of the SEGR gas turbine system 52. In the illustrated embodiment, the SEGR gas turbine system 52 intakes the exhaust gas 66 into a compressor section having one or more compressors, thereby compressing the exhaust gas 66 for use in a combustor section along with an intake of an oxidant 68 and one or more fuels 70. The oxidant 68 may include ambient air, pure oxygen, oxygen-enriched air, oxygen-reduced air, oxygen-nitrogen mixtures, or any suitable oxidant that facilitates combustion of the fuel 70. The fuel 70 may include one or more gas fuels, liquid fuels, or any combination thereof. For example, the fuel 70 may include natural gas, liquefied natural gas (LNG), syngas, methane, ethane, propane, butane, naphtha, kerosene, diesel fuel, ethanol, methanol, biofuel, or any combination thereof.

The SEGR gas turbine system 52 mixes and combusts the exhaust gas 66, the oxidant 68, and the fuel 70 in the combustor section, thereby generating hot combustion gases or exhaust gas 60 to drive one or more turbine stages in a turbine section. In certain embodiments, each combustor in the combustor section includes one or more premix fuel nozzles, one or more diffusion fuel nozzles, or any combination thereof. For example, each premix fuel nozzle may be configured to mix the oxidant 68 and the fuel 70 internally within the fuel nozzle and/or partially upstream of the fuel nozzle, thereby injecting an oxidant-fuel mixture from the fuel nozzle into the combustion zone for a premixed combustion (e.g., a premixed flame). By further example, each diffusion fuel nozzle may be configured to isolate the flows of oxidant 68 and fuel 70 within the fuel nozzle, thereby separately injecting the oxidant 68 and the fuel 70 from the fuel nozzle into the combustion zone for diffusion combustion (e.g., a diffusion flame). In particular, the diffusion combustion provided by the diffusion fuel nozzles delays mixing of the oxidant 68 and the fuel 70 until the point of initial combustion, i.e., the flame region. In embodiments employing the diffusion fuel nozzles, the diffusion flame may provide increased flame stability, because the diffusion flame generally forms at the point of stoichiometry between the separate streams of oxidant 68 and fuel 70 (i.e., as the oxidant 68 and fuel 70 are mixing). In certain embodiments, one or more diluents (e.g., the exhaust gas 60, steam, nitrogen, or another inert gas) may be pre-mixed with the oxidant 68, the fuel 70, or both, in either the diffusion fuel nozzle or the premix fuel nozzle. In addition, one or more diluents (e.g., the exhaust gas 60, steam, nitrogen, or another inert gas) may be injected into the combustor at or downstream from the point of combustion within each combustor. The use of these diluents may help temper the flame (e.g., premix flame or diffusion flame), thereby helping to reduce NO_{X} emissions, such as nitrogen monoxide (NO) and nitrogen dioxide (NO₂). Regardless of the type of flame, the combustion produces hot combustion gases or exhaust gas 60 to drive one or more turbine stages. As each turbine stage is driven by the exhaust gas 60, the SEGR gas turbine system 52 generates a mechanical power 72 and/or an electrical power 74 (e.g., via an electrical generator). The system 52 also outputs the exhaust gas 60, and may further output water 64. Again, the water 64 may be a treated water, such as a desalinated water, which may be useful in a variety of applications on-site or off-site.

Exhaust extraction is also provided by the SEGR gas turbine system 52 using one or more extraction points 76. For example, the illustrated embodiment includes an exhaust gas (EG) supply system 78 having an exhaust gas (EG) extraction system 80 and an exhaust gas (EG) treatment system 82, which receive exhaust gas 42 from the extraction points 76, treat the exhaust gas 42, and then supply or distribute the exhaust gas 42 to various target systems. The target systems may include the EOR system 18 and/or other systems, such as a pipeline 86, a storage tank 88, or a carbon sequestration system 90. The EG extraction system 80 may include one or more conduits, valves, controls, and flow separations, which facilitate isolation of the exhaust gas 42 from the oxidant 68, the fuel 70, and other contaminants, while also controlling the temperature, pressure, and flow rate of the extracted exhaust gas 42. The EG treatment system 82 may include one or more heat exchangers (e.g., heat recovery units such as heat recovery steam generators, condensers, coolers, or heaters), catalyst systems (e.g., oxidation catalyst systems), particulate and/or water removal systems (e.g., gas dehydration units, inertial separators, coalescing filters, water impermeable filters, and other filters), chemical injection systems, solvent based treatment systems (e.g., absorbers, flash tanks, etc.), carbon capture systems, gas separation systems, gas purification systems, and/or a solvent based treatment system, exhaust gas compressors, any combination thereof. These subsystems of the EG treatment system 82 enable control of the temperature, pressure, flow rate, moisture content (e.g., amount of water removal), particulate content (e.g., amount of particulate removal), and gas composition (e.g., percentage of CO₂, N₂, etc.).

The extracted exhaust gas 42 is treated by one or more subsystems of the EG treatment system 82, depending on the target system. For example, the EG treatment system 82 may direct all or part of the exhaust gas 42 through a carbon capture system, a gas separation system, a gas purification system, and/or a solvent based treatment system, which is controlled to separate and purify a carbonaceous gas (e.g., carbon dioxide) 92 and/or nitrogen (N₂) 94 for use in the various target systems. For example, embodiments of the EG treatment system 82 may perform gas separation and purification to produce a plurality of different streams 95 of exhaust gas 42, such as a first stream 96, a second stream 97, and a third stream 98. The first stream 96 may have a first composition that is rich in carbon dioxide and/or lean in nitrogen (e.g., a CO₂ rich, N₂ lean stream). The second stream 97 may have a second composition that has intermediate concentration levels of carbon dioxide and/or nitrogen (e.g., intermediate concentration CO₂, N₂ stream). The third stream 98 may have a third composition that is lean in carbon dioxide and/or rich in nitrogen (e.g., a CO₂ lean, N₂ rich stream). Each stream 95 (e.g., 96, 97, and 98) may include a gas dehydration unit, a filter, a gas compressor, or any combination thereof, to facilitate delivery of the stream 95 to a target system. In certain embodiments, the CO₂ rich, N₂ lean stream 96 may have a CO₂ purity or concentration level of greater than approximately 70, 75, 80, 85, 90, 95, 96, 97, 98, or 99 percent by volume, and a N₂ purity or concentration level of less than approximately 1, 2, 3, 4, 5, 10, 15, 20, 25, or percent by volume. In contrast, the CO₂ lean, N₂ rich stream 98 may have a CO₂ purity or concentration level of less than approximately 1, 2, 3, 4, 5, 10, 15, 20, 25, or percent by volume, and a N₂ purity or concentration level of greater than approximately 70, 75, 80, 85, 90, 95, 96, 97, 98, or 99 percent by volume. The intermediate concentration CO₂, N₂ stream 97 may have a CO₂ purity or concentration level and/or a N₂ purity or concentration level of between approximately 30 to 70, 35 to 65, 40 to 60, or 45 to 55 percent by volume. Although the foregoing ranges are merely non-limiting examples, the CO₂ rich, N₂ lean stream 96 and the CO₂ lean, N₂ rich stream 98 may be particularly well suited for use with the EOR system 18 and the other systems 84. However, any of these rich, lean, or intermediate concentration CO₂ streams 95 may be used, alone or in various combinations, with the EOR system 18 and the other systems 84. For example, the EOR system 18 and the other systems 84 (e.g., the pipeline 86, storage tank 88, and the carbon sequestration system 90) each may receive one or more CO₂ rich, N₂ lean streams 96, one or more CO₂ lean, N₂ rich streams 98, one or more intermediate concentration CO₂, N₂ streams 97, and one or more untreated exhaust gas 42 streams (i.e., bypassing the EG treatment system 82).

The EG extraction system 80 extracts the exhaust gas 42 at one or more extraction points 76 along the compressor section, the combustor section, and/or the turbine section, such that the exhaust gas 42 may be used in the EOR system 18 and other systems 84 at suitable temperatures and pressures. The EG extraction system 80 and/or the EG treatment system 82 also may circulate fluid flows (e.g., exhaust gas 42) to and from the EG processing system 54. For example, a portion of the exhaust gas 42 passing through the EG processing system 54 may be extracted by the EG extraction system 80 for use in the EOR system 18 and the other systems 84. In certain embodiments, the EG supply system 78 and the EG processing system 54 may be independent or integral with one another, and thus may use independent or common subsystems. For example, the EG treatment system 82 may be used by both the EG supply system 78 and the EG processing system 54. Exhaust gas 42 extracted from the EG processing system 54 may undergo multiple stages of gas treatment, such as one or more stages of gas treatment in the EG processing system 54 followed by one or more additional stages of gas treatment in the EG treatment system 82.

At each extraction point 76, the extracted exhaust gas 42 may be substantially free of oxidant 68 and fuel 70 (e.g., unburnt fuel or hydrocarbons) due to substantially stoichiometric combustion and/or gas treatment in the EG processing system 54. Furthermore, depending on the target system, the extracted exhaust gas 42 may undergo further treatment in the EG treatment system 82 of the EG supply system 78, thereby further reducing any residual oxidant 68, fuel 70, or other undesirable products of combustion. For example, either before or after treatment in the EG treatment system 82, the extracted exhaust gas 42 may have less than 1, 2, 3, 4, or 5 percent by volume of oxidant (e.g., oxygen), unburnt fuel or hydrocarbons (e.g., HCs), nitrogen oxides (e.g., NO_{X}), carbon monoxide (CO), sulfur oxides (e.g., SO_{X}), hydrogen, and other products of incomplete combustion. By further example, either before or after treatment in the EG treatment system 82, the extracted exhaust gas 42 may have less than approximately 10, 20, 30, 40, 50, 60, 70, 80, 90, 100, 200, 300, 400, 500, 1000, 2000, 3000, 4000, or 5000 parts per million by volume (ppmv) of oxidant (e.g., oxygen), unburnt fuel or hydrocarbons (e.g., HCs), nitrogen oxides (e.g., NO_{X}), carbon monoxide (CO), sulfur oxides (e.g., SO_{X}), hydrogen, and other products of incomplete combustion. Thus, the exhaust gas 42 is particularly well suited for use with the EOR system 18.

The EGR operation of the turbine system 52 specifically enables the exhaust extraction at a multitude of locations 76. For example, the compressor section of the system 52 may be used to compress the exhaust gas 66 without any oxidant 68 (i.e., only compression of the exhaust gas 66), such that a substantially oxygen-free exhaust gas 42 may be extracted from the compressor section and/or the combustor section prior to entry of the oxidant 68 and the fuel 70. The extraction points 76 may be located at interstage ports between adjacent compressor stages, at ports along the compressor discharge casing, at ports along each combustor in the combustor section, or any combination thereof. In certain embodiments, the exhaust gas 66 may not mix with the oxidant 68 and fuel 70 until it reaches the head end portion and/or fuel nozzles of each combustor in the combustor section. Furthermore, one or more flow separators (e.g., walls, dividers, baffles, or the like) may be used to isolate the oxidant 68 and the fuel 70 from the extraction points 76. With these flow separators, the extraction points 76 may be disposed directly along a wall of each combustor in the combustor section.

Once the exhaust gas 66, oxidant 68, and fuel 70 flow through the head end portion (e.g., through fuel nozzles) into the combustion portion (e.g., combustion chamber) of each combustor, the SEGR gas turbine system 52 is controlled to provide a substantially stoichiometric combustion of the exhaust gas 66, oxidant 68, and fuel 70. For example, the system 52 may maintain an equivalence ratio of approximately 0.95 to approximately 1.05. As a result, the products of combustion of the mixture of exhaust gas 66, oxidant 68, and fuel 70 in each combustor is substantially free of oxygen and unburnt fuel. Thus, the products of combustion (or exhaust gas) may be extracted from the turbine section of the SEGR gas turbine system 52 for use as the exhaust gas 42 routed to the EOR system 18. Along the turbine section, the extraction points 76 may be located at any turbine stage, such as interstage ports between adjacent turbine stages. Thus, using any of the foregoing extraction points 76, the turbine-based service system 14 may generate, extract, and deliver the exhaust gas 42 to the hydrocarbon production system 12 (e.g., the EOR system 18) for use in the production of oil/gas 48 from the subterranean reservoir 20.

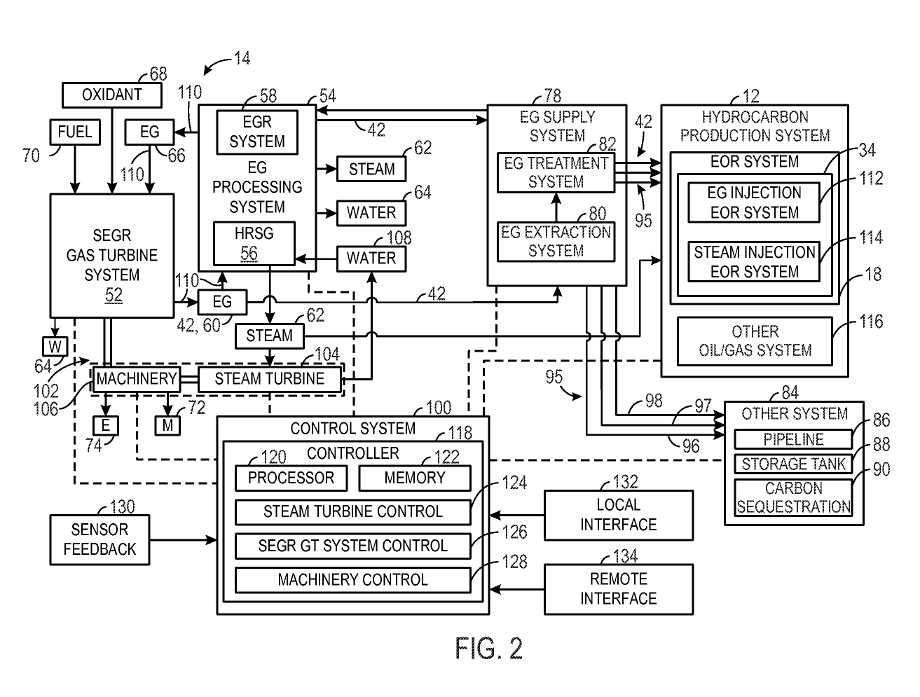

FIG. 2 is a diagram of an embodiment of the system 10 of FIG. 1, illustrating a control system 100 coupled to the turbine-based service system 14 and the hydrocarbon production system 12. In the illustrated embodiment, the turbine-based service system 14 includes a combined cycle system 102, which includes the SEGR gas turbine system 52 as a topping cycle, a steam turbine 104 as a bottoming cycle, and the HRSG 56 to recover heat from the exhaust gas 60 to generate the steam 62 for driving the steam turbine 104. Again, the SEGR gas turbine system 52 receives, mixes, and stoichiometrically combusts the exhaust gas 66, the oxidant 68, and the fuel 70 (e.g., premix and/or diffusion flames), thereby producing the exhaust gas 60, the mechanical power 72, the electrical power 74, and/or the water 64. For example, the SEGR gas turbine system 52 may drive one or more loads or machinery 106, such as an electrical generator, an oxidant compressor (e.g., a main air compressor), a gear box, a pump, equipment of the hydrocarbon production system 12, or any combination thereof. In some embodiments, the machinery 106 may include other drives, such as electrical motors or steam turbines (e.g., the steam turbine 104), in tandem with the SEGR gas turbine system 52. Accordingly, an output of the machinery 106 driven by the SEGR gas turbines system 52 (and any additional drives) may include the mechanical power 72 and the electrical power 74. The mechanical power 72 and/or the electrical power 74 may be used on-site for powering the hydrocarbon production system 12, the electrical power 74 may be distributed to the power grid, or any combination thereof. The output of the machinery 106 also may include a compressed fluid, such as a compressed oxidant 68 (e.g., air or oxygen), for intake into the combustion section of the SEGR gas turbine system 52. Each of these outputs (e.g., the exhaust gas 60, the mechanical power 72, the electrical power 74, and/or the water 64) may be considered a service of the turbine-based service system 14.

The SEGR gas turbine system 52 produces the exhaust gas 42, 60, which may be substantially free of oxygen, and routes this exhaust gas 42, 60 to the EG processing system 54 and/or the EG supply system 78. The EG supply system 78 may treat and delivery the exhaust gas 42 (e.g., streams 95) to the hydrocarbon production system 12 and/or the other systems 84. As discussed above, the EG processing system 54 may include the HRSG 56 and the EGR system 58. The HRSG 56 may include one or more heat exchangers, condensers, and various heat recovery equipment, which may be used to recover or transfer heat from the exhaust gas 60 to water 108 to generate the steam 62 for driving the steam turbine 104. Similar to the SEGR gas turbine system 52, the steam turbine 104 may drive one or more loads or machinery 106, thereby generating the mechanical power 72 and the electrical power 74. In the illustrated embodiment, the SEGR gas turbine system 52 and the steam turbine 104 are arranged in tandem to drive the same machinery 106. However, in other embodiments, the SEGR gas turbine system 52 and the steam turbine 104 may separately drive different machinery 106 to independently generate mechanical power 72 and/or electrical power 74. As the steam turbine 104 is driven by the steam 62 from the HRSG 56, the steam 62 gradually decreases in temperature and pressure. Accordingly, the steam turbine 104 recirculates the used steam 62 and/or water 108 back into the HRSG 56 for additional steam generation via heat recovery from the exhaust gas 60. In addition to steam generation, the HRSG 56, the EGR system 58, and/or another portion of the EG processing system 54 may produce the water 64, the exhaust gas 42 for use with the hydrocarbon production system 12, and the exhaust gas 66 for use as an input into the SEGR gas turbine system 52. For example, the water 64 may be a treated water 64, such as a desalinated water for use in other applications. The desalinated water may be particularly useful in regions of low water availability. Regarding the exhaust gas 60, embodiments of the EG processing system 54 may be configured to recirculate the exhaust gas 60 through the EGR system 58 with or without passing the exhaust gas 60 through the HRSG 56.

In the illustrated embodiment, the SEGR gas turbine system 52 has an exhaust recirculation path 110, which extends from an exhaust outlet to an exhaust inlet of the system 52. Along the path 110, the exhaust gas 60 passes through the EG processing system 54, which includes the HRSG 56 and the EGR system 58 in the illustrated embodiment. The EGR system 58 may include one or more conduits, valves, blowers, gas treatment systems (e.g., filters, particulate removal units, gas separation units, gas purification units, heat exchangers, heat recovery units such as heat recovery steam generators, moisture removal units, catalyst units, chemical injection units, or any combination thereof) in series and/or parallel arrangements along the path 110. In other words, the EGR system 58 may include any flow control components, pressure control components, temperature control components, moisture control components, and gas composition control components along the exhaust recirculation path 110 between the exhaust outlet and the exhaust inlet of the system 52. Accordingly, in embodiments with the HRSG 56 along the path 110, the HRSG 56 may be considered a component of the EGR system 58. However, in certain embodiments, the HRSG 56 may be disposed along an exhaust path independent from the exhaust recirculation path 110. Regardless of whether the HRSG 56 is along a separate path or a common path with the EGR system 58, the HRSG 56 and the EGR system 58 intake the exhaust gas 60 and output either the recirculated exhaust gas 66, the exhaust gas 42 for use with the EG supply system 78 (e.g., for the hydrocarbon production system 12 and/or other systems 84), or another output of exhaust gas. Again, the SEGR gas turbine system 52 intakes, mixes, and stoichiometrically combusts the exhaust gas 66, the oxidant 68, and the fuel 70 (e.g., premixed and/or diffusion flames) to produce a substantially oxygen-free and fuel-free exhaust gas 60 for distribution to the EG processing system 54, the hydrocarbon production system 12, or other systems 84.

As noted above with reference to FIG. 1, the hydrocarbon production system 12 may include a variety of equipment to facilitate the recovery or production of oil/gas 48 from a subterranean reservoir 20 through an oil/gas well 26. For example, the hydrocarbon production system 12 may include the EOR system 18 having the fluid injection system 34. In the illustrated embodiment, the fluid injection system 34 includes an exhaust gas injection EOR system 112 and a steam injection EOR system 114. Although the fluid injection system 34 may receive fluids from a variety of sources, the illustrated embodiment may receive the exhaust gas 42 and the steam 62 from the turbine-based service system 14. The exhaust gas 42 and/or the steam 62 produced by the turbine-based service system 14 also may be routed to the hydrocarbon production system 12 for use in other oil/gas systems 116.

The quantity, quality, and flow of the exhaust gas 42 and/or the steam 62 may be controlled by the control system 100. The control system 100 may be dedicated entirely to the turbine-based service system 14, or the control system 100 may optionally also provide control (or at least some data to facilitate control) for the hydrocarbon production system 12 and/or other systems 84. In the illustrated embodiment, the control system 100 includes a controller 118 having a processor 120, a memory 122, a steam turbine control 124, a SEGR gas turbine system control 126, and a machinery control 128. The processor 120 may include a single processor or two or more redundant processors, such as triple redundant processors for control of the turbine-based service system 14. The memory 122 may include volatile and/or non-volatile memory. For example, the memory 122 may include one or more hard drives, flash memory, read-only memory, random access memory, or any combination thereof. In one embodiment, the control system 100 may include one or more tangible, non-transitory, machine-readable media collectively storing one or more sets of instructions and one or more processing devices configured to execute the one or more sets of instructions. The controls 124, 126, and 128 may include software and/or hardware controls. For example, the controls 124, 126, and 128 may include various instructions or code stored on the memory 122 and executable by the processor 120. The control 124 is configured to control operation of the steam turbine 104, the SEGR gas turbine system control 126 is configured to control the system 52, and the machinery control 128 is configured to control the machinery 106. Thus, the controller 118 (e.g., controls 124, 126, and 128) may be configured to coordinate various sub-systems of the turbine-based service system 14 to provide a suitable stream of the exhaust gas 42 to the hydrocarbon production system 12.

In certain embodiments of the control system 100, each element (e.g., system, subsystem, and component) illustrated in the drawings or described herein includes (e.g., directly within, upstream, or downstream of such element) one or more industrial control features, such as sensors and control devices, which are communicatively coupled with one another over an industrial control network along with the controller 118. For example, the control devices associated with each element may include a dedicated device controller (e.g., including a processor, memory, and control instructions), one or more actuators, valves, switches, and industrial control equipment, which enable control based on sensor feedback 130, control signals from the controller 118, control signals from a user, or any combination thereof. Thus, any of the control functionality described herein may be implemented with control instructions stored and/or executable by the controller 118, dedicated device controllers associated with each element, or a combination thereof.

In order to facilitate such control functionality, the control system 100 includes one or more sensors distributed throughout the system 10 to obtain the sensor feedback 130 for use in execution of the various controls, e.g., the controls 124, 126, and 128. For example, the sensor feedback 130 may be obtained from sensors distributed throughout the SEGR gas turbine system 52, the machinery 106, the EG processing system 54, the steam turbine 104, the hydrocarbon production system 12, or any other components throughout the turbine-based service system 14 or the hydrocarbon production system 12. For example, the sensor feedback 130 may include temperature feedback, pressure feedback, flow rate feedback, flame temperature feedback, combustion dynamics feedback, intake oxidant composition feedback, intake fuel composition feedback, exhaust composition feedback, the output level of mechanical power 72, the output level of electrical power 74, the output quantity of the exhaust gas 42, 60, the output quantity or quality of the water 64, or any combination thereof. For example, the sensor feedback 130 may include a composition of the exhaust gas 42, 60 to facilitate stoichiometric combustion in the SEGR gas turbine system 52. For example, the sensor feedback 130 may include feedback from one or more intake oxidant sensors along an oxidant supply path of the oxidant 68, one or more intake fuel sensors along a fuel supply path of the fuel 70, and one or more exhaust emissions sensors disposed along the exhaust recirculation path 110 and/or within the SEGR gas turbine system 52. The intake oxidant sensors, intake fuel sensors, and exhaust emissions sensors may include temperature sensors, pressure sensors, flow rate sensors, and composition sensors. The emissions sensors may includes sensors for nitrogen oxides (e.g., NO_{X} sensors), carbon oxides (e.g., CO sensors and CO₂ sensors), sulfur oxides (e.g., SO_{X} sensors), hydrogen (e.g., H₂ sensors), oxygen (e.g., O₂ sensors), unburnt hydrocarbons (e.g., HC sensors), or other products of incomplete combustion, or any combination thereof.

Using this feedback 130, the control system 100 may adjust (e.g., increase, decrease, or maintain) the intake flow of exhaust gas 66, oxidant 68, and/or fuel 70 into the SEGR gas turbine system 52 (among other operational parameters) to maintain the equivalence ratio within a suitable range, e.g., between approximately 0.95 to approximately 1.05, between approximately 0.95 to approximately 1.0, between approximately 1.0 to approximately 1.05, or substantially at 1.0. For example, the control system 100 may analyze the feedback 130 to monitor the exhaust emissions (e.g., concentration levels of nitrogen oxides, carbon oxides such as CO and CO₂, sulfur oxides, hydrogen, oxygen, unburnt hydrocarbons, and other products of incomplete combustion) and/or determine the equivalence ratio, and then control one or more components to adjust the exhaust emissions (e.g., concentration levels in the exhaust gas 42) and/or the equivalence ratio. The controlled components may include any of the components illustrated and described with reference to the drawings, including but not limited to, valves along the supply paths for the oxidant 68, the fuel 70, and the exhaust gas 66; an oxidant compressor, a fuel pump, or any components in the EG processing system 54; any components of the SEGR gas turbine system 52, or any combination thereof. The controlled components may adjust (e.g., increase, decrease, or maintain) the flow rates, temperatures, pressures, or percentages (e.g., equivalence ratio) of the oxidant 68, the fuel 70, and the exhaust gas 66 that combust within the SEGR gas turbine system 52. The controlled components also may include one or more gas treatment systems, such as catalyst units (e.g., oxidation catalyst units), supplies for the catalyst units (e.g., oxidation fuel, heat, electricity, etc.), gas purification and/or separation units (e.g., solvent based separators, absorbers, flash tanks, etc.), and filtration units. The gas treatment systems may help reduce various exhaust emissions along the exhaust recirculation path 110, a vent path (e.g., exhausted into the atmosphere), or an extraction path to the EG supply system 78.

In certain embodiments, the control system 100 may analyze the feedback 130 and control one or more components to maintain or reduce emissions levels (e.g., concentration levels in the exhaust gas 42, 60, 95) to a target range, such as less than approximately 10, 20, 30, 40, 50, 100, 200, 300, 400, 500, 1000, 2000, 3000, 4000, 5000, or 10000 parts per million by volume (ppmv). These target ranges may be the same or different for each of the exhaust emissions, e.g., concentration levels of nitrogen oxides, carbon monoxide, sulfur oxides, hydrogen, oxygen, unburnt hydrocarbons, and other products of incomplete combustion. For example, depending on the equivalence ratio, the control system 100 may selectively control exhaust emissions (e.g., concentration levels) of oxidant (e.g., oxygen) within a target range of less than approximately 10, 20, 30, 40, 50, 60, 70, 80, 90, 100, 250, 500, 750, or 1000 ppmv; carbon monoxide (CO) within a target range of less than approximately 20, 50, 100, 200, 500, 1000, 2500, or 5000 ppmv; and nitrogen oxides (NO_{X}) within a target range of less than approximately 50, 100, 200, 300, 400, or 500 ppmv. In certain embodiments operating with a substantially stoichiometric equivalence ratio, the control system 100 may selectively control exhaust emissions (e.g., concentration levels) of oxidant (e.g., oxygen) within a target range of less than approximately 10, 20, 30, 40, 50, 60, 70, 80, 90, or 100 ppmv; and carbon monoxide (CO) within a target range of less than approximately 500, 1000, 2000, 3000, 4000, or 5000 ppmv. In certain embodiments operating with a fuel-lean equivalence ratio (e.g., between approximately 0.95 to 1.0), the control system 100 may selectively control exhaust emissions (e.g., concentration levels) of oxidant (e.g., oxygen) within a target range of less than approximately 500, 600, 700, 800, 900, 1000, 1100, 1200, 1300, 1400, or 1500 ppmv; carbon monoxide (CO) within a target range of less than approximately 10, 20, 30, 40, 50, 60, 70, 80, 90, 100, 150, or 200 ppmv; and nitrogen oxides (e.g., NO_{X}) within a target range of less than approximately 50, 100, 150, 200, 250, 300, 350, or 400 ppmv. The foregoing target ranges are merely examples, and are not intended to limit the scope of the disclosed embodiments.

The control system 100 also may be coupled to a local interface 132 and a remote interface 134. For example, the local interface 132 may include a computer workstation disposed on-site at the turbine-based service system 14 and/or the hydrocarbon production system 12. In contrast, the remote interface 134 may include a computer workstation disposed off-site from the turbine-based service system 14 and the hydrocarbon production system 12, such as through an internet connection. These interfaces 132 and 134 facilitate monitoring and control of the turbine-based service system 14, such as through one or more graphical displays of sensor feedback 130, operational parameters, and so forth.

Again, as noted above, the controller 118 includes a variety of controls 124, 126, and 128 to facilitate control of the turbine-based service system 14. The steam turbine control 124 may receive the sensor feedback 130 and output control commands to facilitate operation of the steam turbine 104. For example, the steam turbine control 124 may receive the sensor feedback 130 from the HRSG 56, the machinery 106, temperature and pressure sensors along a path of the steam 62, temperature and pressure sensors along a path of the water 108, and various sensors indicative of the mechanical power 72 and the electrical power 74. Likewise, the SEGR gas turbine system control 126 may receive sensor feedback 130 from one or more sensors disposed along the SEGR gas turbine system 52, the machinery 106, the EG processing system 54, or any combination thereof. For example, the sensor feedback 130 may be obtained from temperature sensors, pressure sensors, clearance sensors, vibration sensors, flame sensors, fuel composition sensors, exhaust gas composition sensors, or any combination thereof, disposed within or external to the SEGR gas turbine system 52. Finally, the machinery control 128 may receive sensor feedback 130 from various sensors associated with the mechanical power 72 and the electrical power 74, as well as sensors disposed within the machinery 106. Each of these controls 124, 126, and 128 uses the sensor feedback 130 to improve operation of the turbine-based service system 14.

In the illustrated embodiment, the SEGR gas turbine system control 126 may execute instructions to control the quantity and quality of the exhaust gas 42, 60, 95 in the EG processing system 54, the EG supply system 78, the hydrocarbon production system 12, and/or the other systems 84. For example, the SEGR gas turbine system control 126 may maintain a level of oxidant (e.g., oxygen) and/or unburnt fuel in the exhaust gas 60 below a threshold suitable for use with the exhaust gas injection EOR system 112. In certain embodiments, the threshold levels may be less than 1, 2, 3, 4, or 5 percent of oxidant (e.g., oxygen) and/or unburnt fuel by volume of the exhaust gas 42, 60; or the threshold levels of oxidant (e.g., oxygen) and/or unburnt fuel (and other exhaust emissions) may be less than approximately 10, 20, 30, 40, 50, 60, 70, 80, 90, 100, 200, 300, 400, 500, 1000, 2000, 3000, 4000, or 5000 parts per million by volume (ppmv) in the exhaust gas 42, 60. By further example, in order to achieve these low levels of oxidant (e.g., oxygen) and/or unburnt fuel, the SEGR gas turbine system control 126 may maintain an equivalence ratio for combustion in the SEGR gas turbine system 52 between approximately 0.95 and approximately 1.05. The SEGR gas turbine system control 126 also may control the EG extraction system 80 and the EG treatment system 82 to maintain the temperature, pressure, flow rate, and gas composition of the exhaust gas 42, 60, 95 within suitable ranges for the exhaust gas injection EOR system 112, the pipeline 86, the storage tank 88, and the carbon sequestration system 90. As discussed above, the EG treatment system 82 may be controlled to purify and/or separate the exhaust gas 42 into one or more gas streams 95, such as the CO₂ rich, N₂ lean stream 96, the intermediate concentration CO₂, N₂ stream 97, and the CO₂ lean, N₂ rich stream 98. In addition to controls for the exhaust gas 42, 60, and 95, the controls 124, 126, and 128 may execute one or more instructions to maintain the mechanical power 72 within a suitable power range, or maintain the electrical power 74 within a suitable frequency and power range.

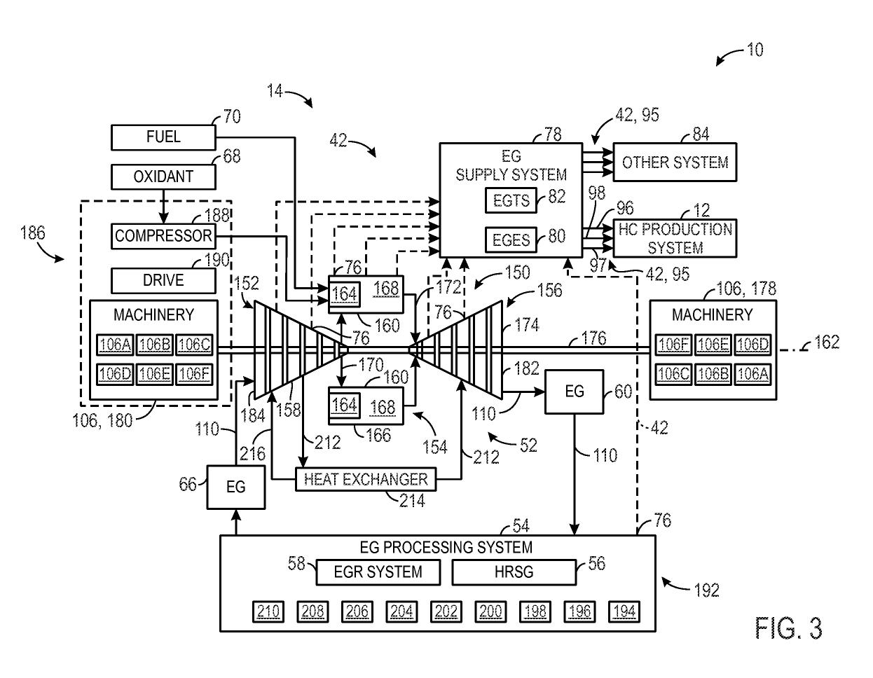

FIG. 3 is a diagram of embodiment of the system 10, further illustrating details of the SEGR gas turbine system 52 for use with the hydrocarbon production system 12 and/or other systems 84. In the illustrated embodiment, the SEGR gas turbine system 52 includes a gas turbine engine 150 coupled to the EG processing system 54. The illustrated gas turbine engine 150 includes a compressor section 152, a combustor section 154, and an expander section or turbine section 156. The compressor section 152 includes one or more exhaust gas compressors or compressor stages 158, such as 1 to 20 stages of rotary compressor blades disposed in a series arrangement. Likewise, the combustor section 154 includes one or more combustors 160, such as 1 to 20 combustors 160 distributed circumferentially about a rotational axis 162 of the SEGR gas turbine system 52. Furthermore, each combustor 160 may include one or more fuel nozzles 164 configured to inject the exhaust gas 66, the oxidant 68, and/or the fuel 70. For example, a head end portion 166 of each combustor 160 may house 1, 2, 3, 4, 5, 6, or more fuel nozzles 164, which may inject streams or mixtures of the exhaust gas 66, the oxidant 68, and/or the fuel 70 into a combustion portion 168 (e.g., combustion chamber) of the combustor 160.

The fuel nozzles 164 may include any combination of premix fuel nozzles 164 (e.g., configured to premix the oxidant 68 and fuel 70 for generation of an oxidant/fuel premix flame) and/or diffusion fuel nozzles 164 (e.g., configured to inject separate flows of the oxidant 68 and fuel 70 for generation of an oxidant/fuel diffusion flame). Embodiments of the premix fuel nozzles 164 may include swirl vanes, mixing chambers, or other features to internally mix the oxidant 68 and fuel 70 within the nozzles 164, prior to injection and combustion in the combustion chamber 168. The premix fuel nozzles 164 also may receive at least some partially mixed oxidant 68 and fuel 70. In certain embodiments, each diffusion fuel nozzle 164 may isolate flows of the oxidant 68 and the fuel 70 until the point of injection, while also isolating flows of one or more diluents (e.g., the exhaust gas 66, steam, nitrogen, or another inert gas) until the point of injection. In other embodiments, each diffusion fuel nozzle 164 may isolate flows of the oxidant 68 and the fuel 70 until the point of injection, while partially mixing one or more diluents (e.g., the exhaust gas 66, steam, nitrogen, or another inert gas) with the oxidant 68 and/or the fuel 70 prior to the point of injection. In addition, one or more diluents (e.g., the exhaust gas 66, steam, nitrogen, or another inert gas) may be injected into the combustor (e.g., into the hot products of combustion) either at or downstream from the combustion zone, thereby helping to reduce the temperature of the hot products of combustion and reduce emissions of NO_{X} (e.g., NO and NO₂). Regardless of the type of fuel nozzle 164, the SEGR gas turbine system 52 may be controlled to provide substantially stoichiometric combustion of the oxidant 68 and fuel 70.

In diffusion combustion embodiments using the diffusion fuel nozzles 164, the fuel 70 and oxidant 68 generally do not mix upstream from the diffusion flame, but rather the fuel 70 and oxidant 68 mix and react directly at the flame surface and/or the flame surface exists at the location of mixing between the fuel 70 and oxidant 68. In particular, the fuel 70 and oxidant 68 separately approach the flame surface (or diffusion boundary/interface), and then diffuse (e.g., via molecular and viscous diffusion) along the flame surface (or diffusion boundary/interface) to generate the diffusion flame. It is noteworthy that the fuel 70 and oxidant 68 may be at a substantially stoichiometric ratio along this flame surface (or diffusion boundary/interface), which may result in a greater flame temperature (e.g., a peak flame temperature) along this flame surface. The stoichiometric fuel/oxidant ratio generally results in a greater flame temperature (e.g., a peak flame temperature), as compared with a fuel-lean or fuel-rich fuel/oxidant ratio. As a result, the diffusion flame may be substantially more stable than a premix flame, because the diffusion of fuel 70 and oxidant 68 helps to maintain a stoichiometric ratio (and greater temperature) along the flame surface. Although greater flame temperatures can also lead to greater exhaust emissions, such as NO_{X} emissions, the disclosed embodiments use one or more diluents to help control the temperature and emissions while still avoiding any premixing of the fuel 70 and oxidant 68. For example, the disclosed embodiments may introduce one or more diluents separate from the fuel 70 and oxidant 68 (e.g., after the point of combustion and/or downstream from the diffusion flame), thereby helping to reduce the temperature and reduce the emissions (e.g., NO_{X} emissions) produced by the diffusion flame.

In operation, as illustrated, the compressor section 152 receives and compresses the exhaust gas 66 from the EG processing system 54, and outputs a compressed exhaust gas 170 to each of the combustors 160 in the combustor section 154. Upon combustion of the fuel 60, oxidant 68, and exhaust gas 170 within each combustor 160, additional exhaust gas or products of combustion 172 (i.e., combustion gas) is routed into the turbine section 156. Similar to the compressor section 152, the turbine section 156 includes one or more turbines or turbine stages 174, which may include a series of rotary turbine blades. These turbine blades are then driven by the products of combustion 172 generated in the combustor section 154, thereby driving rotation of a shaft 176 coupled to the machinery 106. Again, the machinery 106 may include a variety of equipment coupled to either end of the SEGR gas turbine system 52, such as machinery 106, 178 coupled to the turbine section 156 and/or machinery 106, 180 coupled to the compressor section 152. In certain embodiments, the machinery 106, 178, 180 may include one or more electrical generators, oxidant compressors for the oxidant 68, fuel pumps for the fuel 70, gear boxes, or additional drives (e.g. steam turbine 104, electrical motor, etc.) coupled to the SEGR gas turbine system 52. Non-limiting examples are discussed in further detail below with reference to TABLE 1. As illustrated, the turbine section 156 outputs the exhaust gas 60 to recirculate along the exhaust recirculation path 110 from an exhaust outlet 182 of the turbine section 156 to an exhaust inlet 184 into the compressor section 152. Along the exhaust recirculation path 110, the exhaust gas 60 passes through the EG processing system 54 (e.g., the HRSG 56 and/or the EGR system 58) as discussed in detail above.

Again, each combustor 160 in the combustor section 154 receives, mixes, and stoichiometrically combusts the compressed exhaust gas 170, the oxidant 68, and the fuel 70 to produce the additional exhaust gas or products of combustion 172 to drive the turbine section 156. In certain embodiments, the oxidant 68 is compressed by an oxidant compression system 186, such as a main oxidant compression (MOC) system (e.g., a main air compression (MAC) system) having one or more oxidant compressors (MOCs). The oxidant compression system 186 includes an oxidant compressor 188 coupled to a drive 190. For example, the drive 190 may include an electric motor, a combustion engine, or any combination thereof. In certain embodiments, the drive 190 may be a turbine engine, such as the gas turbine engine 150. Accordingly, the oxidant compression system 186 may be an integral part of the machinery 106. In other words, the compressor 188 may be directly or indirectly driven by the mechanical power 72 supplied by the shaft 176 of the gas turbine engine 150. In such an embodiment, the drive 190 may be excluded, because the compressor 188 relies on the power output from the turbine engine 150. However, in certain embodiments employing more than one oxidant compressor is employed, a first oxidant compressor (e.g., a low pressure (LP) oxidant compressor) may be driven by the drive 190 while the shaft 176 drives a second oxidant compressor (e.g., a high pressure (HP) oxidant compressor), or vice versa. For example, in another embodiment, the HP MOC is driven by the drive 190 and the LP oxidant compressor is driven by the shaft 176. In the illustrated embodiment, the oxidant compression system 186 is separate from the machinery 106. In each of these embodiments, the compression system 186 compresses and supplies the oxidant 68 to the fuel nozzles 164 and the combustors 160. Accordingly, some or all of the machinery 106, 178, 180 may be configured to increase the operational efficiency of the compression system 186 (e.g., the compressor 188 and/or additional compressors).

The variety of components of the machinery 106, indicated by element numbers 106A, 106B, 106C, 106D, 106E, and 106F, may be disposed along the line of the shaft 176 and/or parallel to the line of the shaft 176 in one or more series arrangements, parallel arrangements, or any combination of series and parallel arrangements. For example, the machinery 106, 178, 180 (e.g., 106A through 106F) may include any series and/or parallel arrangement, in any order, of: one or more gearboxes (e.g., parallel shaft, epicyclic gearboxes), one or more compressors (e.g., oxidant compressors, booster compressors such as EG booster compressors), one or more power generation units (e.g., electrical generators), one or more drives (e.g., steam turbine engines, electrical motors), heat exchange units (e.g., direct or indirect heat exchangers), clutches, or any combination thereof. The compressors may include axial compressors, radial or centrifugal compressors, or any combination thereof, each having one or more compression stages. Regarding the heat exchangers, direct heat exchangers may include spray coolers (e.g., spray intercoolers), which inject a liquid spray into a gas flow (e.g., oxidant flow) for direct cooling of the gas flow. Indirect heat exchangers may include at least one wall (e.g., a shell and tube heat exchanger) separating first and second flows, such as a fluid flow (e.g., oxidant flow) separated from a coolant flow (e.g., water, air, refrigerant, or any other liquid or gas coolant), wherein the coolant flow transfers heat from the fluid flow without any direct contact. Examples of indirect heat exchangers include intercooler heat exchangers and heat recovery units, such as heat recovery steam generators. The heat exchangers also may include heaters. As discussed in further detail below, each of these machinery components may be used in various combinations as indicated by the non-limiting examples set forth in TABLE 1.

Generally, the machinery 106, 178, 180 may be configured to increase the efficiency of the compression system 186 by, for example, adjusting operational speeds of one or more oxidant compressors in the system 186, facilitating compression of the oxidant 68 through cooling, and/or extraction of surplus power. The disclosed embodiments are intended to include any and all permutations of the foregoing components in the machinery 106, 178, 180 in series and parallel arrangements, wherein one, more than one, all, or none of the components derive power from the shaft 176. As illustrated below, TABLE 1 depicts some non-limiting examples of arrangements of the machinery 106, 178, 180 disposed proximate and/or coupled to the compressor and turbine sections 152, 156.

TABLE 1

| 106A | 106B | 106C | 106D | 106E | 106F |
|---|---|---|---|---|---|
| MOC | GEN | | | | |
| MOC | GBX | GEN | | | |
| LP | HP | GEN | | | |
| MOC | MOC | | | | |
| HP | GBX | LP | GEN | | |
| MOC | | MOC | | | |
| MOC | GBX | GEN | | | |
| MOC | | | | | |
| HP | GBX | GEN | LP | | |
| MOC | | | MOC | | |
| MOC | GBX | GEN | | | |
| MOC | GBX | DRV | | | |
| DRV | GBX | LP | HP | GBX | GEN |
| | | MOC | MOC | | |
| DRV | GBX | HP | LP | GEN | |
| | | MOC | MOC | | |
| HP | GBX | LP | GEN | | |
| MOC | CLR | MOC | | | |
| HP | GBX | LP | GBX | GEN | |
| MOC | CLR | MOC | | | |
| HP | GBX | LP | GEN | | |
| MOC | HTR | MOC | | | |
| | STGN | | | | |
| MOC | GEN | DRV | | | |
| MOC | DRV | GEN | | | |
| DRV | MOC | GEN | | | |
| DRV | CLU | MOC | GEN | | |
| DRV | CLU | MOC | GBX | GEN | |

As illustrated above in TABLE 1, a cooling unit is represented as CLR, a clutch is represented as CLU, a drive is represented by DRV, a gearbox is represented as GBX, a generator is represented by GEN, a heating unit is represented by HTR, a main oxidant compressor unit is represented by MOC, with low pressure and high pressure variants being represented as LP MOC and HP MOC, respectively, and a steam generator unit is represented as STGN. Although TABLE 1 illustrates the machinery 106, 178, 180 in sequence toward the compressor section 152 or the turbine section 156, TABLE 1 is also intended to cover the reverse sequence of the machinery 106, 178, 180. In TABLE 1, any cell including two or more components is intended to cover a parallel arrangement of the components. TABLE 1 is not intended to exclude any non-illustrated permutations of the machinery 106, 178, 180. These components of the machinery 106, 178, 180 may enable feedback control of temperature, pressure, and flow rate of the oxidant 68 sent to the gas turbine engine 150. As discussed in further detail below, the oxidant 68 and the fuel 70 may be supplied to the gas turbine engine 150 at locations specifically selected to facilitate isolation and extraction of the compressed exhaust gas 170 without any oxidant 68 or fuel 70 degrading the quality of the exhaust gas 170.

The EG supply system 78, as illustrated in FIG. 3, is disposed between the gas turbine engine 150 and the target systems (e.g., the hydrocarbon production system 12 and the other systems 84). In particular, the EG supply system 78, e.g., the EG extraction system (EGES) 80), may be coupled to the gas turbine engine 150 at one or more extraction points 76 along the compressor section 152, the combustor section 154, and/or the turbine section 156. For example, the extraction points 76 may be located between adjacent compressor stages, such as 2, 3, 4, 5, 6, 7, 8, 9, or 10 interstage extraction points 76 between compressor stages. Each of these interstage extraction points 76 provides a different temperature and pressure of the extracted exhaust gas 42. Similarly, the extraction points 76 may be located between adjacent turbine stages, such as 2, 3, 4, 5, 6, 7, 8, 9, or 10 interstage extraction points 76 between turbine stages. Each of these interstage extraction points 76 provides a different temperature and pressure of the extracted exhaust gas 42. By further example, the extraction points 76 may be located at a multitude of locations throughout the combustor section 154, which may provide different temperatures, pressures, flow rates, and gas compositions. Each of these extraction points 76 may include an EG extraction conduit, one or more valves, sensors, and controls, which may be used to selectively control the flow of the extracted exhaust gas 42 to the EG supply system 78.

The extracted exhaust gas 42, which is distributed by the EG supply system 78, has a controlled composition suitable for the target systems (e.g., the hydrocarbon production system 12 and the other systems 84). For example, at each of these extraction points 76, the exhaust gas 170 may be substantially isolated from injection points (or flows) of the oxidant 68 and the fuel 70. In other words, the EG supply system 78 may be specifically designed to extract the exhaust gas 170 from the gas turbine engine 150 without any added oxidant 68 or fuel 70. Furthermore, in view of the stoichiometric combustion in each of the combustors 160, the extracted exhaust gas 42 may be substantially free of oxygen and fuel. The EG supply system 78 may route the extracted exhaust gas 42 directly or indirectly to the hydrocarbon production system 12 and/or other systems 84 for use in various processes, such as enhanced oil recovery, carbon sequestration, storage, or transport to an offsite location. However, in certain embodiments, the EG supply system 78 includes the EG treatment system (EGTS) 82 for further treatment of the exhaust gas 42, prior to use with the target systems. For example, the EG treatment system 82 may purify and/or separate the exhaust gas 42 into one or more streams 95, such as the CO₂ rich, N₂ lean stream 96, the intermediate concentration CO₂, N₂ stream 97, and the CO₂ lean, N₂ rich stream 98. These treated exhaust gas streams 95 may be used individually, or in any combination, with the hydrocarbon production system 12 and the other systems 84 (e.g., the pipeline 86, the storage tank 88, and the carbon sequestration system 90).

Similar to the exhaust gas treatments performed in the EG supply system 78, the EG processing system 54 may include a plurality of exhaust gas (EG) treatment components 192, such as indicated by element numbers 194, 196, 198, 200, 202, 204, 206, 208, and 210. These EG treatment components 192 (e.g., 194 through 210) may be disposed along the exhaust recirculation path 110 in one or more series arrangements, parallel arrangements, or any combination of series and parallel arrangements. For example, the EG treatment components 192 (e.g., 194 through 210) may include any series and/or parallel arrangement, in any order, of: one or more heat exchangers (e.g., heat recovery units such as heat recovery steam generators, condensers, coolers, or heaters), catalyst systems (e.g., oxidation catalyst systems), particulate and/or water removal systems (e.g., inertial separators, coalescing filters, water impermeable filters, and other filters), chemical injection systems, solvent based treatment systems (e.g., absorbers, flash tanks, etc.), carbon capture systems, gas separation systems, gas purification systems, and/or a solvent based treatment system, or any combination thereof. In certain embodiments, the catalyst systems may include an oxidation catalyst, a carbon monoxide reduction catalyst, a nitrogen oxides reduction catalyst, an aluminum oxide, a zirconium oxide, a silicone oxide, a titanium oxide, a platinum oxide, a palladium oxide, a cobalt oxide, or a mixed metal oxide, or a combination thereof. The disclosed embodiments are intended to include any and all permutations of the foregoing components 192 in series and parallel arrangements. As illustrated below, TABLE 2 depicts some non-limiting examples of arrangements of the components 192 along the exhaust recirculation path 110.

TABLE 2

| 194 | 196 | 198 | 200 | 202 | 204 | 206 | 208 | 210 |
|---|---|---|---|---|---|---|---|---|
| CU | HRU | BB | MRU | PRU | | | | |
| CU | HRU | HRU | BB | MRU | PRU | DIL | | |
| CU | HRSG | HRSG | BB | MRU | PRU | | | |
| OCU | HRU | OCU | HRU | OCU | BB | MRU | PRU | |
| HRU | HRU | BB | MRU | PRU | | | | |
| CU | CU | | | | | | | |
| HRSG | HRSG | BB | MRU | PRU | DIL | | | |
| OCU | OCU | | | | | | | |
| OCU | HRSG | OCU | HRSG | OCU | BB | MRU | PRU | DIL |
| | OCU | | OCU | | | | | |
| OCU | HRSG | HRSG | BB | COND | INER | WFIL | CFIL | DIL |
| | ST | ST | | | | | | |
| OCU | OCU | BB | COND | INER | FIL | DIL | | |
| HRSG | HRSG | | | | | | | |
| ST | ST | | | | | | | |
| OCU | HRSG | HRSG | OCU | BB | MRU | MRU | PRU | PRU |
| | ST | ST | | | HE | WFIL | INER | FIL |
| | | | | | COND | | | CFIL |
| CU | HRU | HRU | HRU | BB | MRU | PRU | PRU | DIL |
| | COND | COND | COND | | HE | INER | FIL | |
| | | | | | COND | | CFIL | |
| | | | | | WFIL | | | |

As illustrated above in TABLE 2, a catalyst unit is represented by CU, an oxidation catalyst unit is represented by OCU, a booster blower is represented by BB, a heat exchanger is represented by HX, a heat recovery unit is represented by HRU, a heat recovery steam generator is represented by HRSG, a condenser is represented by COND, a steam turbine is represented by ST, a particulate removal unit is represented by PRU, a moisture removal unit is represented by MRU, a filter is represented by FIL, a coalescing filter is represented by CFIL, a water impermeable filter is represented by WFIL, an inertial separator is represented by INER, and a diluent supply system (e.g., steam, nitrogen, or other inert gas) is represented by DIL. Although TABLE 2 illustrates the components 192 in sequence from the exhaust outlet 182 of the turbine section 156 toward the exhaust inlet 184 of the compressor section 152, TABLE 2 is also intended to cover the reverse sequence of the illustrated components 192. In TABLE 2, any cell including two or more components is intended to cover an integrated unit with the components, a parallel arrangement of the components, or any combination thereof. Furthermore, in context of TABLE 2, the HRU, the HRSG, and the COND are examples of the HE; the HRSG is an example of the HRU; the COND, WFIL, and CFIL are examples of the WRU; the INER, FIL, WFIL, and CFIL are examples of the PRU; and the WFIL and CFIL are examples of the FIL. Again, TABLE 2 is not intended to exclude any non-illustrated permutations of the components 192. In certain embodiments, the illustrated components 192 (e.g., 194 through 210) may be partially or completed integrated within the HRSG 56, the EGR system 58, or any combination thereof. These EG treatment components 192 may enable feedback control of temperature, pressure, flow rate, and gas composition, while also removing moisture and particulates from the exhaust gas 60. Furthermore, the treated exhaust gas 60 may be extracted at one or more extraction points 76 for use in the EG supply system 78 and/or recirculated to the exhaust inlet 184 of the compressor section 152.

As the treated, recirculated exhaust gas 66 passes through the compressor section 152, the SEGR gas turbine system 52 may bleed off a portion of the compressed exhaust gas along one or more lines 212 (e.g., bleed conduits or bypass conduits). Each line 212 may route the exhaust gas into one or more heat exchangers 214 (e.g., cooling units), thereby cooling the exhaust gas for recirculation back into the SEGR gas turbine system 52. For example, after passing through the heat exchanger 214, a portion of the cooled exhaust gas may be routed to the turbine section 156 along line 212 for cooling and/or sealing of the turbine casing, turbine shrouds, bearings, and other components. In such an embodiment, the SEGR gas turbine system 52 does not route any oxidant 68 (or other potential contaminants) through the turbine section 156 for cooling and/or sealing purposes, and thus any leakage of the cooled exhaust gas will not contaminate the hot products of combustion (e.g., working exhaust gas) flowing through and driving the turbine stages of the turbine section 156. By further example, after passing through the heat exchanger 214, a portion of the cooled exhaust gas may be routed along line 216 (e.g., return conduit) to an upstream compressor stage of the compressor section 152, thereby improving the efficiency of compression by the compressor section 152. In such an embodiment, the heat exchanger 214 may be configured as an interstage cooling unit for the compressor section 152. In this manner, the cooled exhaust gas helps to increase the operational efficiency of the SEGR gas turbine system 52, while simultaneously helping to maintain the purity of the exhaust gas (e.g., substantially free of oxidant and fuel).

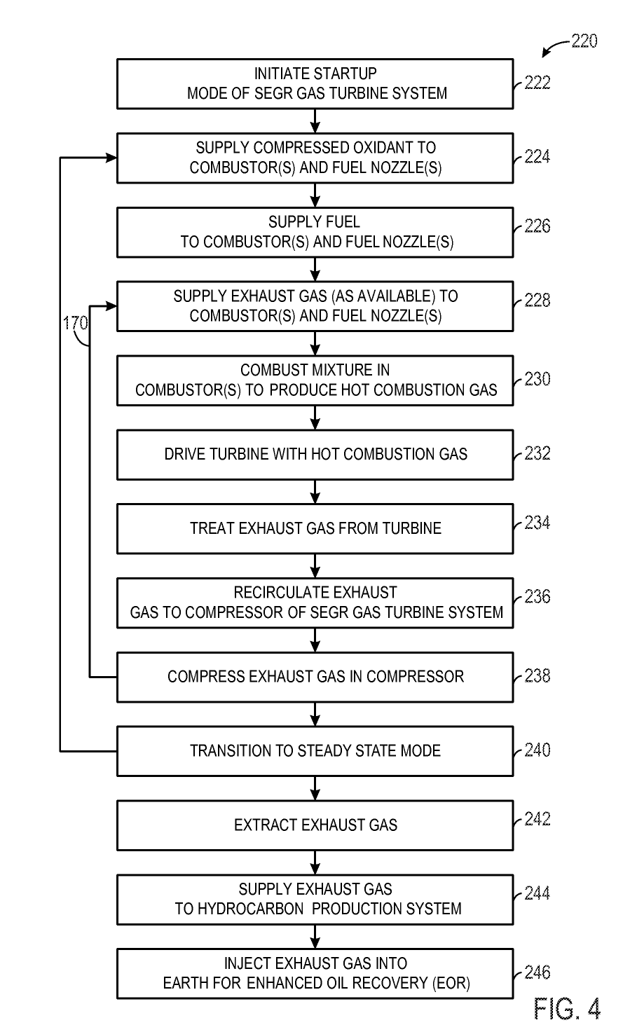

FIG. 4 is a flow chart of an embodiment of an operational process 220 of the system 10 illustrated in FIGS. 1-3. In certain embodiments, the process 220 may be a computer implemented process, which accesses one or more instructions stored on the memory 122 and executes the instructions on the processor 120 of the controller 118 shown in FIG. 2. For example, each step in the process 220 may include instructions executable by the controller 118 of the control system 100 described with reference to FIG. 2.

The process 220 may begin by initiating a startup mode of the SEGR gas turbine system 52 of FIGS. 1-3, as indicated by block 222. For example, the startup mode may involve a gradual ramp up of the SEGR gas turbine system 52 to maintain thermal gradients, vibration, and clearance (e.g., between rotating and stationary parts) within acceptable thresholds. For example, during the startup mode 222, the process 220 may begin to supply a compressed oxidant 68 to the combustors 160 and the fuel nozzles 164 of the combustor section 154, as indicated by block 224. In certain embodiments, the compressed oxidant may include a compressed air, oxygen, oxygen-enriched air, oxygen-reduced air, oxygen-nitrogen mixtures, or any combination thereof. For example, the oxidant 68 may be compressed by the oxidant compression system 186 illustrated in FIG. 3. The process 220 also may begin to supply fuel to the combustors 160 and the fuel nozzles 164 during the startup mode 222, as indicated by block 226. During the startup mode 222, the process 220 also may begin to supply exhaust gas (as available) to the combustors 160 and the fuel nozzles 164, as indicated by block 228. For example, the fuel nozzles 164 may produce one or more diffusion flames, premix flames, or a combination of diffusion and premix flames. During the startup mode 222, the exhaust gas 60 being generated by the gas turbine engine 156 may be insufficient or unstable in quantity and/or quality. Accordingly, during the startup mode, the process 220 may supply the exhaust gas 66 from one or more storage units (e.g., storage tank 88), the pipeline 86, other SEGR gas turbine systems 52, or other exhaust gas sources.

The process 220 may then combust a mixture of the compressed oxidant, fuel, and exhaust gas in the combustors 160 to produce hot combustion gas 172, as indicated by block 230. In particular, the process 220 may be controlled by the control system 100 of FIG. 2 to facilitate stoichiometric combustion (e.g., stoichiometric diffusion combustion, premix combustion, or both) of the mixture in the combustors 160 of the combustor section 154. However, during the startup mode 222, it may be particularly difficult to maintain stoichiometric combustion of the mixture (and thus low levels of oxidant and unburnt fuel may be present in the hot combustion gas 172). As a result, in the startup mode 222, the hot combustion gas 172 may have greater amounts of residual oxidant 68 and/or fuel 70 than during a steady state mode as discussed in further detail below. For this reason, the process 220 may execute one or more control instructions to reduce or eliminate the residual oxidant 68 and/or fuel 70 in the hot combustion gas 172 during the startup mode.

The process 220 then drives the turbine section 156 with the hot combustion gas 172, as indicated by block 232. For example, the hot combustion gas 172 may drive one or more turbine stages 174 disposed within the turbine section 156. Downstream of the turbine section 156, the process 220 may treat the exhaust gas 60 from the final turbine stage 174, as indicated by block 234. For example, the exhaust gas treatment 234 may include filtration, catalytic reaction of any residual oxidant 68 and/or fuel 70, chemical treatment, heat recovery with the HRSG 56, and so forth. The process 220 may also recirculate at least some of the exhaust gas 60 back to the compressor section 152 of the SEGR gas turbine system 52, as indicated by block 236. For example, the exhaust gas recirculation 236 may involve passage through the exhaust recirculation path 110 having the EG processing system 54 as illustrated in FIGS. 1-3.

In turn, the recirculated exhaust gas 66 may be compressed in the compressor section 152, as indicated by block 238. For example, the SEGR gas turbine system 52 may sequentially compress the recirculated exhaust gas 66 in one or more compressor stages 158 of the compressor section 152. Subsequently, the compressed exhaust gas 170 may be supplied to the combustors 160 and fuel nozzles 164, as indicated by block 228. Steps 230, 232, 234, 236, and 238 may then repeat, until the process 220 eventually transitions to a steady state mode, as indicated by block 240. Upon the transition 240, the process 220 may continue to perform the steps 224 through 238, but may also begin to extract the exhaust gas 42 via the EG supply system 78, as indicated by block 242. For example, the exhaust gas 42 may be extracted from one or more extraction points 76 along the compressor section 152, the combustor section 154, and the turbine section 156 as indicated in FIG. 3. In turn, the process 220 may supply the extracted exhaust gas 42 from the EG supply system 78 to the hydrocarbon production system 12, as indicated by block 244. The hydrocarbon production system 12 may then inject the exhaust gas 42 into the earth 32 for enhanced oil recovery, as indicated by block 246. For example, the extracted exhaust gas 42 may be used by the exhaust gas injection EOR system 112 of the EOR system 18 illustrated in FIGS. 1-3.

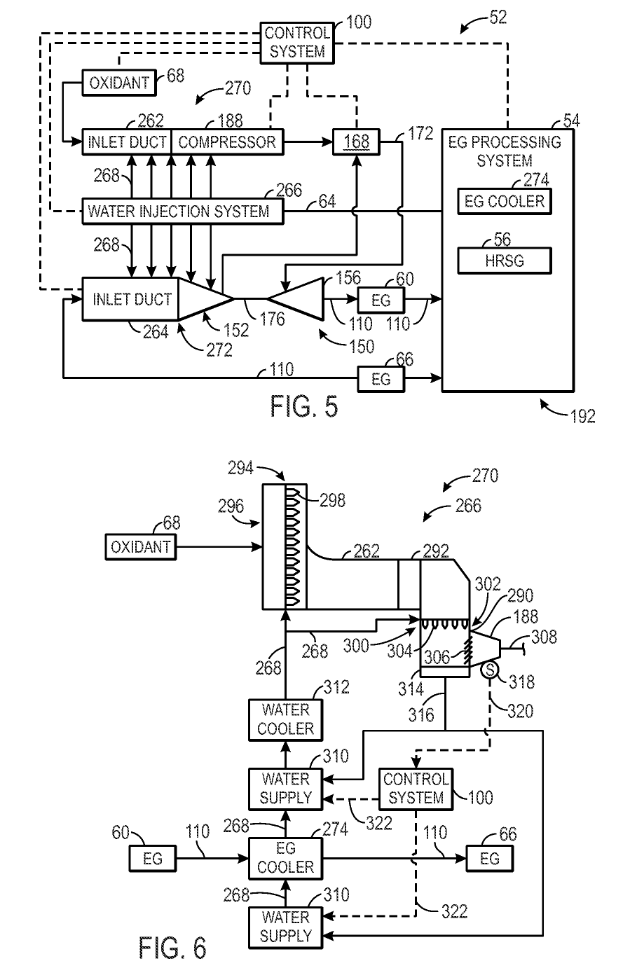

FIG. 5 is a schematic diagram of an embodiment of the SEGR gas turbine system 52. Elements in FIG. 5 in common with those shown in previous figures are labeled with the same reference numerals. In the illustrated embodiment, an oxidant inlet duct 262 is coupled to the oxidant compressor 188. The oxidant inlet duct 262 conveys the oxidant 68 to the oxidant compressor 188. In certain embodiments, an exhaust gas inlet duct 264 may be coupled to the compressor section 152 of the gas turbine engine 150. The compressor section 152 may also be referred to as an exhaust gas compressor. As shown in FIG. 5, the exhaust gas inlet duct 264 conveys the exhaust gas 66 to the exhaust gas compressor 152. A water injection system 266 may inject cooling water 268 (e.g., liquid water spray, water vapor or steam, or a combination thereof) into one or more locations of at least one of the oxidant inlet duct 262, the oxidant compressor 188, the exhaust gas inlet duct 264, or the exhaust gas compressor 152, or any combination thereof. The cooling water 268 may include, but is not limited to, demineralized water, desalinated water, the treated water 64, or boiler feedwater, or any combination thereof. In certain embodiments, demineralized water or the like may help to avoid the formation of mineral deposits within the oxidant compressor 188 and/or the exhaust gas compressor 152. The oxidant inlet duct 262 and the oxidant compressor 188 may be generally referred to together as an oxidant compressor system 270. Similarly, the exhaust gas inlet duct 264 and the exhaust gas compressor 152 may be generally referred to together as an exhaust gas compressor system 272. As shown in FIG. 5, a single water injection system 266 may be used to inject the cooling water 268 to both the oxidant compressor system 270 and the exhaust gas compressor system 272. In other embodiments, separate water injection systems 266 may be used to individually supply the cooling water 268 to the oxidant compressor system 270 and the exhaust gas compressor system 272. In such embodiments, the separate water injection systems 266 may be used to supply the individual requirements for the cooling water 268 in the oxidant compressor system 270 and the exhaust gas compressor system 272. In further embodiments, the water injection system 266 may be used either for the oxidant compressor system 270 or the exhaust gas compressor system 272, but not both. As discussed in detail below, the water injection system 266 may be used to improve the operability of the oxidant compressor system 270 and/or the exhaust gas compressor system 272.

Each of the different embodiments discussed above may also correspond to different control modes of the SEGR gas turbine system 52. For example, the control system 100 may be used to operate the SEGR gas turbine system 52 in one or more different modes based on sensor feedback, such as, but not limited to, a startup mode, a steady-state mode, a continuous spray (e.g., injection) mode, a pulsating spray mode, a variable spray mode, an inlet spray mode, an interstage spray mode, a multistage spray mode, and so forth.

As discussed above, the EG processing system 54 may include a variety of components in certain embodiments. For example, the EG processing system 54 may include the HRSG 56, which transfers heat from the exhaust gas 60 to a stream of water, thereby generating steam 62. In addition, the HRSG 56 may also produce the treated water 64. In some embodiments, the EG processing system 54 may include an exhaust gas cooler 274 to cool the exhaust gas 60. The exhaust gas cooler 274 may use cooling water to cool the exhaust gas 60, thereby generating the treated water 64 or may use the treated water 64 for cooling the exhaust gas 60. Cooling the exhaust gas 60 may provide certain benefits to the SEGR gas turbine system 52, such as, increasing an efficiency of catalyst systems (e.g., oxidation catalyst systems). In certain embodiments, the exhaust gas cooler 274 may be part of the HRSG 56. Other exhaust gas treatment components 192 of the EG processing system 54 may also produce the treated water 64. In general, the treated water 64 or any water used to supply the water injection system 266 may come from the bottoming (steam) portion of the turbine-based service system 14. The treated water 64 may be conveyed from the EG processing system 54 to the water injection system 266 to be injected into the oxidant compressor system 270 and/or the exhaust gas compressor system 272. As shown in FIG. 5, the control system 100 may be used to control one or more aspects of the gas turbine system 52, such as the injection of the treated water 64 by the water injection system 266 into the oxidant compressor system 270 and/or the exhaust gas compressor system 272. By using water that is already being generated by the EG processing system 54 (e.g., treated water 64), use of an additional source of water for the water injection system 266 may be avoided, thereby decreasing the operating costs associated with the SEGR gas turbine system 52. In addition, use of the treated water 64 by the water injection system 266 may help utilize a source of waste heat (i.e., energy recovery).

FIG. 6 is a schematic diagram of an embodiment of the oxidant compressor system 270 and the water injection system 266. As shown in FIG. 6, the oxidant inlet duct 262 is coupled to an oxidant inlet 290 of the oxidant compressor 188. Specifically, the oxidant inlet 290 may refer to the location where the oxidant 68 enters the oxidant compressor 188. Thus, the oxidant inlet duct 262 conveys the oxidant 68 to the oxidant inlet 290 of the oxidant compressor 188. In certain embodiments, the oxidant inlet duct 262 may include an oxidant silencer 292 configured to reduce the noise associated with the flow of the oxidant 68 through the oxidant inlet duct 262 to the oxidant compressor 188. In further embodiments, the oxidant inlet duct 262 may include other components associated with compressor duct systems.

The water injection system 266 may be used to inject the cooling water 268 into various locations along the length of the oxidant inlet duct 262. For example, the water injection system 266 may include an oxidant inlet fogging system 294 disposed near an inlet 296 of the oxidant inlet duct 262. In certain embodiments, the oxidant inlet fogging system 294 may be disposed upstream of the oxidant silencer 292. As shown in FIG. 6, the oxidant inlet fogging system 294 may include a plurality of oxidant inlet fogging injectors 298 (e.g., 1 to 1000, 10 to 500, or 20 to 100 injectors), which may be any type of spray nozzles for receiving the cooling water 268 and providing a spray of the cooling water 268 (e.g., spray of water droplets) into the oxidant inlet duct 262, such as, but not limited to, impact-pin nozzles, swirl spray nozzles, and so forth. The spray of the cooling water 268 generated by the plurality of oxidant inlet fogging injectors 298 may include many fine liquid water droplets that evaporate before reaching the oxidant inlet 290 of the oxidant compressor 188, thereby decreasing a temperature of the oxidant 68 and increasing a density of the oxidant 68 (or oxidant-water mixture). By decreasing the temperature of the oxidant 68 and increasing the density of the oxidant 68, additional mass flow of the oxidant 68 is available to be compressed by the oxidant compressor 188, thereby increasing the mass flow rate available to, increasing the efficiency of, and/or decreasing the power and/or work used to drive the oxidant compressor 188.

In other embodiments, the water injection system 266 may include an oxidant wet compression system 300 disposed near an outlet 302 of the oxidant inlet duct 262. In other words, the oxidant wet compression system 300 may be disposed near the oxidant inlet 290 of the oxidant compressor 188. In certain embodiments, the oxidant wet compression system 300 may be disposed downstream of the oxidant silencer 292. As shown in FIG. 6, the oxidant wet compression system 300 may include a plurality of oxidant wet compression injectors 304 (e.g., 1 to 1000, 10 to 500, or 20 to 100 injectors) to provide a spray of the cooling water 268 (e.g., liquid water droplets) into the oxidant inlet duct 262. The plurality of oxidant wet compression injectors 304 may be similar to the plurality of oxidant inlet fogging injectors 298 described in detail above. The cooling water 268 injected by the plurality of wet compression injectors 304 may evaporate as the oxidant 68 is compressed within the oxidant compressor 188. In other words, the droplets of the cooling water 268 from the oxidant wet compression system 300 do not completely evaporate prior to reaching the oxidant inlet 290. In contrast, the cooling water 268 injected by the oxidant inlet fogging system 294 may substantially or completely evaporate (e.g., greater than or equal to 60, 70, 80, 90, 95, or 100 percent evaporation) prior to reaching the oxidant inlet 290. Thus, the cooling water 268 injected by the oxidant wet compression system 300 alters the thermodynamics of the compression process within the oxidant compressor 188 from an adiabatic process to a nearly isothermal process. Because isothermal processes use less work (i.e., power to drive the compressor) for a given amount of compression, more work is left available for useful application, such as electricity production or other forms of mechanical work. Thus, the oxidant wet compression system 300 may be used to decrease the work and/or power used to drive the oxidant compressor 188. In other embodiments, the water injection system 266 may be used to inject the cooling water 268 into other locations of the oxidant compressor system 270, such as, but not limited to, the oxidant inlet 290, one or more stages of the oxidant compressor 188, between one or more stages of the oxidant compressor 188, or any combination thereof.

In the illustrated embodiment, oxidant inlet guide vanes 306 are disposed at the oxidant inlet 290 and may be used to adjust the flow rate of the oxidant 68 entering the oxidant compressor 188. For example, the control system 100 may increase an angle of the oxidant inlet guide vanes 306 to reduce the flow rate of the oxidant 68 or the control system 100 may decrease the angle of the oxidant inlet guide vanes 306 to increase the flow rate of the oxidant 68 via one or more actuators. Specifically, by increasing the angle of the oxidant inlet guide vanes 306, a larger surface area of the oxidant inlet guide vanes 306 is disposed against the flow of the oxidant 68, thereby blocking and/or reducing the flow rate of the oxidant 68. Thus, the oxidant inlet guide vanes 306 may be used to adjust the flow rate of the oxidant 68 entering the oxidant compressor 188. By using the oxidant inlet fogging system 294 and/or the oxidant wet compression system 300, the oxidant inlet guide vanes 306 may be operated with a smaller angle than possible without using the oxidant inlet fogging system 294 and/or the oxidant wet compression system 300, thereby increasing the efficiency of the oxidant compressor 188.

In addition, use of the oxidant inlet fogging system 294 and/or the oxidant wet compression system 300 may enable the oxidant compressor 188 to operate closer to a shaft torque limit. Specifically, the oxidant compressor 188 may be coupled to an oxidant compressor shaft 308. The torque limit of the oxidant compressor shaft 308 may be determined or established based on mechanical properties of the oxidant compressor shaft 308 and/or the oxidant compressor 188. Therefore, operation of the oxidant compressor 188 above the torque limit of the oxidant compressor shaft 308 may be undesirable. However, operation of the oxidant compressor 188 close to or near the torque limit of the oxidant compressor shaft 308 may increase the efficiency of the oxidant compressor 188. By using the oxidant inlet fogging system 294 and/or the oxidant wet compression system 300, increased flow of the oxidant 68 within the torque limit of the oxidant compressor shaft 308 may be possible because of the increased efficiency of the oxidant compressor 188. For example, the control system 100 may determine a difference between the torque of the oxidant compressor shaft 308 and the torque limit of the oxidant compressor shaft 308. The control system 100 may then adjust operation of the oxidant inlet fogging system 294 and/or the oxidant wet compression system 300 to maintain the difference between the torque and the torque limit within a desired range. A small value may be selected for the range to enable the oxidant compressor 188 to operate close to the torque limit of the oxidant compressor shaft 308.

As shown in FIG. 6, the exhaust gas 60 enters the exhaust gas cooler 274 to be cooled and exits as the exhaust gas 66. The exhaust gas cooler 274 may be any type of heat exchanger used to cool gaseous streams such as the exhaust gas 60. Specifically, the exhaust gas cooler 274 may be an indirect heat exchanger, such as a shell and tube heat exchanger, that uses indirect heat exchange between the exhaust gas 60 and the cooling water 268. In other embodiments, the exhaust gas cooler 274 may be a direct heat exchanger or a combination of a direct and indirect heat exchanger. In certain embodiments, a water supply system 310 may be used to convey the treated water 64 to the exhaust gas cooler 274, thereby generating the cooling water 268. As discussed above, the water supply system 310 may include the HRSG 56, the exhaust gas (EG) processing system 54, or the stoichiometric exhaust gas recirculation (SEGR) gas turbine system 52, or any combination thereof. The water supply system 310 may include at least one of a pump, or a control valve, or any combination thereof, to convey and/or adjust a flow rate of the treated water 64 to the exhaust gas cooler 274 and/or the cooling water 268 from the exhaust gas cooler 274. In certain embodiments, the water supply system 310 disposed upstream of the exhaust gas cooler 274 may also be used to convey the cooling water 268 to one or both of the oxidant inlet fogging system 284 and the oxidant wet compression system 300. In other embodiments, separate water supply systems 310 may be disposed downstream of the exhaust gas cooler 274 and used to convey the cooling water 268 to the oxidant inlet fogging system 284 and the oxidant wet compression system 300. In further embodiments, a water cooler 312 may be disposed between the exhaust gas cooler 274 and one or both of the oxidant inlet fogging system 294 and the oxidant wet compression system 300. The water cooler 312 may be used to reduce a temperature of the cooling water 268 from the exhaust gas cooler 274 and may be useful when additional cooling of the cooling water 268 to the oxidant inlet fogging system 294 and/or the oxidant wet compression system 300 is desired. The water cooler 312 may be any type of direct and/or indirect heat exchanger used to cool fluids, such as the cooling water 268. In other embodiments, the water cooler 312 may be omitted.

In the illustrated embodiment, the oxidant inlet duct 262 includes an oxidant water drain 314 that may collect and capture unevaporated cooling water 268 from one or both of the oxidant inlet fogging system 294 and the oxidant wet compression system 300. Thus, the oxidant water drain 314 may be used to reduce accumulation of unevaporated cooling water 268 within the oxidant inlet duct 262. The unevaporated cooling water 268 collected by the oxidant water drain 314 may be conveyed to the water supply system 310 or the exhaust gas cooler 274 via an oxidant water drain conduit 316 to be reused in one or both of the oxidant inlet fogging system 294 and the oxidant wet compression system 300. In other embodiments, the oxidant water drain 314 and the oxidant water drain conduit 316 may be omitted.

As shown in FIG. 6, the control system 100 may be used to control one or more aspects of the oxidant inlet fogging system 294 and/or the oxidant wet compression system 300. For example, one or more sensors 318 may be disposed within the oxidant compressor system 270. For example, the sensors 318 may provide input signals 320 to the control system 100 indicative of a property of the oxidant compressor 188, the oxidant 68 flowing through the oxidant compressor system 270, and/or the cooling water 268 flowing through the oxidant compressor system 270. For example, the input signal 320 may be indicative of a pressure, flow rate, composition, or any combination thereof, of the oxidant 68. In one embodiment, the input signal 320 may be indicative of a level of the cooling water 268 in the oxidant water drain 314. In another embodiment, the input signal 320 may be indicative of a droplet size of the injected cooling water 268. In response to the input signal 320, the control system 100 may generate one or more output signals 322 that are sent to the water supply system 310 to adjust operation of the oxidant inlet fogging system 294 and/or the oxidant wet compression system 300 via a pump motor, a control valve actuator, and so forth. For example, the water supply system 310 may be used to adjust a temperature, a flow rate, a pressure, a droplet size, or a composition, or any combination thereof, of the cooling water 268. Thus, by adjusting the property of the cooling water 268 via the water supply system 310, the control system 100 may be able to at least one of increase the mass flow rate available to the oxidant compressor 188, decrease the work and/or power used to drive the oxidant compressor 188, increase the efficiency of the oxidant compressor 188, or maintain the difference between the shaft torque of the oxidant compressor 188 and the shaft torque limit of the oxidant compressor 188 within a range, or any combination thereof. In addition, the control system 100 may reduce the amount of cooling water 268 injected by the oxidant inlet fogging system 294 and/or the oxidant wet compression system 300 if the input signal 320 indicates an undesirably high level in the oxidant water drain 314. In further embodiments, the control system 100 may reduce the amount of the injected cooling water 268 if the detected droplet size is above a size threshold value to help prevent erosion and/or pitting of the blades of the oxidant compressor 188 or to help ensure complete evaporation. Alternatively, the control system 100 may increase the amount of the injected cooling water 268 to provide additional cooling of the oxidant 68 as long as the droplet size does not exceed the size threshold or a number of droplets (e.g., droplet count) does not exceed a number threshold. In addition, the pressure of the injected cooling water 268 may be controlled as a function of droplet size and/or count. In further embodiments, the control system 100 may be used to maintain a temperature of the cooling water 268 used in the oxidant inlet fogging system 294 below a threshold (e.g., cooler temperatures are preferred to increase the density of the oxidant 68) and/or maintain the temperature of the cooling water 268 used in the oxidant wet compression system 300 above a threshold (e.g., warmer temperatures may be useful as warmer compressed oxidant means that less fuel is used for heating to the peak or firing temperature of the gas turbine engine 150). The control system 100 may also be used to help prevent any internal temperatures of the oxidant compressor 188 from exceeding a threshold. In further embodiments, the control system 100 may receive sensor feedback indicate of other properties of the SEGR gas turbine system 52, such as, but not limited to, combustion properties, exhaust emissions and/or compositions, flame temperatures, and so forth. Thus, such sensor feedback may be used by the control system 100 to adjust the water injection system 266 to help with control of stoichiometric combustion, and/or reducing residual oxidant or unburnt fuel in the exhaust gas.

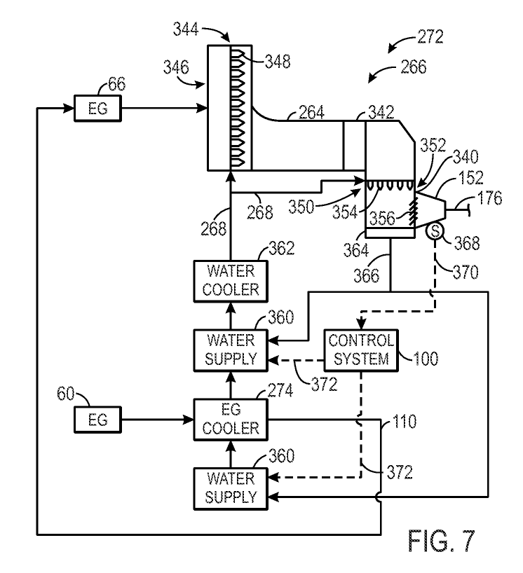

FIG. 7 is a schematic diagram of an embodiment of the exhaust gas compression system 272 and the water injection system 266. Elements in FIG. 7 in common with those shown in previous figures are labeled with the same reference numerals. The water injection system 266 may be used with the exhaust gas compression system 272 in a like manner to the use of the water injection system 266 with the oxidant compressor system 270 shown in FIG. 6. For example, the exhaust gas inlet duct 264 may be coupled to an exhaust gas inlet 340 of the exhaust gas compressor 152. An exhaust gas silencer 342 may be disposed in the exhaust gas inlet duct 264 to reduce noise associated with the flow of the exhaust gas 66 through the exhaust gas inlet duct 264. An exhaust gas inlet fogging system 344 may be disposed near an exhaust gas inlet 346 of the exhaust gas inlet duct 264 and, in certain embodiments, may be disposed upstream of the exhaust gas silencer 342. The exhaust gas inlet fogging system 344 may include a plurality of exhaust gas inlet fogging injectors 348 (e.g., 1 to 1000, 10 to 500, or 20 to 100 injectors) to inject the cooling water 268 into the exhaust gas 66 flowing through the exhaust gas inlet duct 264. The exhaust gas inlet fogging system 344 may increase a mass flow rate available to the exhaust gas compressor 152, increase an efficiency of the exhaust gas compressor 152, and/or decrease a power and/or work used to drive the exhaust gas compressor 152.

An exhaust gas wet compression system 350 may be disposed near an exhaust gas outlet 352 of the exhaust gas inlet duct 264. In other words, the exhaust gas wet compression system 350 may be disposed upstream of the exhaust gas inlet 340 of the exhaust gas compressor 152 and, in certain embodiments, may be disposed downstream of the exhaust gas silencer 342. The exhaust gas wet compression system 350 may include a plurality of exhaust gas wet compression injectors 354 (e.g., 1 to 1000, 10 to 500, or 20 to 100 injectors) to inject the cooling water 268 into the exhaust gas 66 upstream of the exhaust gas compressor 152. The exhaust gas wet compression system 350 may decrease the work and/or power used to drive the oxidant compressor 152. Specifically, the exhaust gas wet compression system 350 may alter the thermodynamics of the compression process within the exhaust gas compressor 152 from an adiabatic process to a nearly isothermal process. In some embodiments, the water injection system 266 may be used to inject the cooling water 268 into other locations of the exhaust gas compressor system 272, such as, but not limited to, the exhaust gas inlet 340, one or more stages of the exhaust gas compressor 152, between one or more stages of the exhaust gas compressor 152, or any combination thereof.

Exhaust gas inlet guide vanes 356 may be disposed at the inlet 340 and used to adjust the flow rate of the exhaust gas 66 entering the exhaust gas compressor 152 via one or more actuators. By using the exhaust gas inlet fogging system 344 and/or the exhaust gas wet compression system 350, the exhaust gas inlet guide vanes 356 may be operated with a smaller angle than possible without using the exhaust gas inlet fogging system 344 and/or the exhaust gas wet compression system 350 because of the increased efficiency of the exhaust gas compressor 152. In addition, the exhaust gas inlet fogging system 344 and/or the exhaust gas wet compression system 350 may be used to maintain a difference between a torque of the shaft 176 and a torque limit of the shaft 176 within a desired range.

As shown in FIG. 7, an exhaust gas water supply system 360 may be used to supply the treated water 64 to the exhaust gas cooler 274 and/or the cooling water 268 to one or both of the exhaust gas inlet fogging system 344 and the exhaust gas wet compression system 350. The exhaust gas water supply system 360 may include components similar to that of the oxidant water supply system 310. In certain embodiments, an exhaust gas water cooler 362 may be disposed between the exhaust water supply system 360 and the exhaust inlet fogging system 344 and/or the exhaust gas wet compression system 350 to provide additional cooling of the cooling water 268. In other embodiments, the exhaust gas water cooler 362 may be omitted.

In the illustrated embodiment, an exhaust gas water drain 364 may be disposed in the exhaust gas inlet duct 264 to collect unevaporated cooling water 268. The unevaporated cooling water 268 from the exhaust gas water drain 364 may be conveyed to the exhaust gas water supply system 360 or the exhaust gas cooler 274 via an exhaust gas water drain conduit 366 to be reused as the injected cooling water 268. In other embodiments, the exhaust gas water drain 364 and the exhaust gas water drain conduit 366 may be omitted.

As shown in FIG. 7, one or more exhaust gas sensors 368 may be disposed within the exhaust gas compression system 272. Each of the exhaust gas sensors 368 may generate an exhaust gas output signal 370 that is sent to the control system 100. The control system 100 may generate one or more exhaust gas output signals 372 that are sent to the exhaust gas water supply system 360 based at least in part on the information conveyed by the exhaust gas input signal 370. For example, the control system 100 may be used to adjust the property of the cooling water 268, such as the temperature, flow rate, pressure, droplet size, or composition, or any combination thereof, via the exhaust gas water supply system 360 to at least one of increase the mass flow rate available to the exhaust gas compressor 152, decrease the work and/or power used to drive the exhaust gas compressor 152, increase an efficiency of the exhaust gas compressor 152, or maintain a difference between the shaft torque of the exhaust gas compressor 152 and the shaft torque limit of the exhaust gas compressor 152 within a range, or any combination thereof. In other respects, the use of the water injection system 266 with the exhaust gas compression system 272 is similar to that described above with respect to the oxidant compressor system 270.

As described above, certain embodiments of the gas turbine engine 150 may include a compressor configured to compress a gaseous stream, such as exhaust gas in the exhaust gas compressor 152 or oxidant in the oxidant compressor 188. The exhaust gas cooler 274 may cool the exhaust gas 60 using the cooling water 268. The water injection system 266 may be used to inject the cooling water 268 from the outlet of the exhaust gas cooler 274 into the oxidant compressor system 270 and/or the exhaust gas compression system 272. For example, the oxidant inlet fogging system 294 and/or the oxidant wet compression system 300 may be used to inject the cooling water 268 into the oxidant inlet duct 262. In some embodiments, the water injection system 266 may be used to inject the cooling water 268 into at least one of the oxidant inlet 290 of the oxidant compressor 188, one or more stages of the oxidant compressor 188, between one or more stages of the oxidant compressor 188, or any combination thereof. In some embodiments, the exhaust gas inlet fogging system 344 and/or the exhaust gas wet compression system 350 may be used to inject the cooling water 268 into the exhaust gas inlet duct 264. In some embodiments, the water injection system 266 may be used to inject the cooling water 268 into at least one of the exhaust gas inlet 340 of the exhaust gas compressor 152, one or more stages of the exhaust gas compressor 152, between one or more stages of the exhaust gas compressor 152, or any combination thereof. By using the water injection system 266 with the exhaust gas compressor 152 and/or the oxidant compressor 188, the mass flow rate available to the compressors 152 and 188 may be increased, the work and/or power used to drive the compressors 152 and 188 may be decreased, and/or the efficiency of compressors 152 and 188 may be increased. In addition, the difference between the shaft torque and the shaft torque limit of one or both of the compressors 152 and 188 may be maintained within a desired range using the water injection system 266.

### ADDITIONAL DESCRIPTION

The present embodiments provide systems and methods for gas turbine engines. It should be noted that any one or a combination of the features described above may be utilized in any suitable combination. Indeed, all permutations of such combinations are presently contemplated. By way of example, the following clauses are offered as further description of the present disclosure:

### Embodiment 1

A system, comprising: a compressor configured to compress a gaseous stream; an exhaust gas cooler configured to cool an exhaust gas from combustion with a cooling water; and a water injection system configured to inject the cooling water from the exhaust gas cooler into at least one of a compressor inlet of the compressor, a stage of the compressor, between stages of the compressor, or an inlet duct coupled to the compressor inlet of the compressor, or any combination thereof.

### Embodiment 2

The system of embodiment 1, comprising the inlet duct configured to convey the gaseous stream to the inlet of the compressor.

### Embodiment 3

The system defined in any proceeding embodiment, wherein the compressor comprises an oxidant compressor configured to compress an oxidant to produce a compressed oxidant.

### Embodiment 4

The system defined in any proceeding embodiment, comprising: a gas turbine engine, comprising: a combustor section having one or more combustors configured to generate combustion products by combusting a fuel with the compressed oxidant; and a turbine section having one or more turbine stages, wherein the one or more turbine stages are driven by the combustion products, wherein the exhaust gas cooler is configured to cool the combustion products as the exhaust gas using the cooling water.

### Embodiment 5

The system defined in any proceeding embodiment, comprising an exhaust gas extraction system coupled to the gas turbine engine, and a hydrocarbon production system coupled to the exhaust gas extraction system.

### Embodiment 6

The system defined in any proceeding embodiment, wherein the gas turbine engine is a stoichiometric exhaust gas recirculation (SEGR) gas turbine engine.

### Embodiment 7

The system defined in any proceeding embodiment, wherein the compressor comprises an exhaust gas compressor configured to compress the exhaust gas to produce a compressed exhaust gas.

### Embodiment 8

The system defined in any proceeding embodiment, comprising: a gas turbine engine, comprising: a combustor section having one or more combustors configured to generate combustion products by combusting a fuel with an oxidant; and a turbine section having one or more turbine stages, wherein the one or more turbine stages are driven by the combustion products, wherein the exhaust gas compressor is driven by the turbine section and is configured to route the compressed exhaust gas to the combustor section, and wherein the exhaust gas cooler is configured to cool the combustion products as the exhaust gas using the cooling water.

### Embodiment 9

The system defined in any proceeding embodiment, comprising an exhaust gas extraction system coupled to the gas turbine engine, and a hydrocarbon production system coupled to the exhaust gas extraction system.

### Embodiment 10

The system defined in any proceeding embodiment, wherein the gas turbine engine is a stoichiometric exhaust gas recirculation (SEGR) gas turbine engine.

### Embodiment 11

The system defined in any proceeding embodiment, wherein the water injection system comprises a plurality of injectors disposed at least adjacent a duct inlet of the inlet duct, adjacent the compressor inlet, adjacent a duct outlet of the inlet duct, upstream of a silencer disposed in the inlet duct, or downstream of the silencer, or any combination thereof.

### Embodiment 12

The system defined in any proceeding embodiment, wherein the water injection system comprises at least one of a wet compression injection system, or inlet fogging injection system, or any combination thereof.

### Embodiment 13

The system defined in any proceeding embodiment, comprising a plurality of inlet guide vanes disposed at the inlet of the compressor, wherein the plurality of inlet guide vanes are configured to be adjusted in response to a flow rate of the cooling water injected by the water injection system.

### Embodiment 14

The system defined in any proceeding embodiment, comprising a water supply system configured to convey the cooling water to the exhaust gas cooler, or from the exhaust gas cooler to the water injection system, or any combination thereof.

### Embodiment 15

The system defined in any proceeding embodiment, wherein the water supply system comprises at least one of a heat recovery steam generator (HRSG) configured to generate steam from the exhaust gas, an exhaust gas (EG) processing system configured to receive and process the exhaust gas, or a stoichiometric exhaust gas recirculation (SEGR) gas turbine system configured to stoichiometrically combust a fuel and an oxidant to generate the exhaust gas, or any combination thereof.

### Embodiment 16

The system defined in any proceeding embodiment, wherein the water supply system comprises at least one of a pump, or a control valve, or any combination thereof.

### Embodiment 17

The system defined in any proceeding embodiment, wherein the water supply system is configured to adjust a property of the cooling water, wherein the property comprises at least one of a temperature, a flow rate, a pressure, a droplet size, or a composition, or any combination thereof.

### Embodiment 18

The system defined in any proceeding embodiment, comprising a controller configured to adjust the property of the cooling water via the water supply system to at least one of increase a mass flow rate available to the compressor, decrease power used to drive the compressor, decrease work used to drive the compressor, increase an efficiency of the compressor, or maintain a difference between a shaft torque of the compressor and a shaft torque limit of the compressor within a range, or any combination thereof.

### Embodiment 19

The system defined in any proceeding embodiment, wherein the cooling water comprises at least one of demineralized water, desalinated water, treated water, or boiler feedwater, or any combination thereof.

### Embodiment 20

The system defined in any proceeding embodiment, comprising a drain coupled to the inlet duct and configured to collect unevaporated cooling water from the inlet duct.

### Embodiment 21

The system defined in any proceeding embodiment, comprising a drain conduit configured to provide the unevaporated cooling water to at least one of the exhaust gas cooler, or the water injection system, or any combination thereof.

### Embodiment 22

The system defined in any proceeding embodiment, comprising a water cooler configured to cool the cooling water from the exhaust gas cooler prior to injection by the water injection system.

### Embodiment 23

A system, comprising: a controller, comprising: one or more tangible, non-transitory, machine-readable media collectively storing one or more sets of instructions; and one or more processing devices configured to execute the one or more sets of instructions to: compress a gaseous stream using a compressor; cool an exhaust gas from combustion with a cooling water using an exhaust gas cooler; and inject the cooling water from the exhaust gas cooler into at least one of a compressor inlet of the compressor, a stage of the compressor, between stages of the compressor, or an inlet duct coupled to the compressor inlet of the compressor, or any combination thereof, using a water injection system.

### Embodiment 24

The system defined in any proceeding embodiment, wherein the one or more processing devices are configured to execute the one or more sets of instructions to: receive an input signal indicative of a property of the gaseous stream determine a shaft torque of the compressor based at least on the input signal compare the shaft torque with a shaft torque limit of the compressor determine a water flow rate of the cooling water to be injected by the water injection system to maintain a difference between the shaft torque and the shaft torque limit within a range; an transmit an output signal indicative of the water flow rate to the water injection system.

### Embodiment 25

The system defined in any proceeding embodiment, wherein the property of the gaseous stream comprises at least one of a temperature, a pressure, a flow rate, or a composition, or any combination thereof.

### Embodiment 26

The system defined in any proceeding embodiment, wherein the compressor comprises an oxidant compressor configured to compress an oxidant to produce a compressed oxidant or an exhaust gas compressor configured to compress the exhaust gas to produce a compressed exhaust gas.

### Embodiment 27

The system defined in any proceeding embodiment, comprises at least one of a wet compression injection system, or inlet fogging injection system, or any combination thereof.

### Embodiment 28

The system defined in any proceeding embodiment, wherein the one or more processing devices are configured to execute the one or more sets of instructions to: receive an input signal indicative of the flow rate of the cooling water; determine an angle of a plurality of inlet guide vanes disposed at the inlet of the compressor based at least in part on the flow rate of the cooling water; an transmit an output signal indicative of the angle to the plurality of inlet guide vanes.

### Embodiment 29

The system defined in any proceeding embodiment, comprising a water supply system configured to convey the cooling water to the exhaust gas cooler, or from the exhaust gas cooler to the water injection system, or any combination thereof.

### Embodiment 30

The system defined in any proceeding embodiment, wherein the one or more processing devices are configured to execute the one or more sets of instructions to: receive an input signal indicative of a property of the gaseous stream; determine a shaft torque of the compressor based at least on the input signal; compare the shaft torque with a shaft torque limit of the compressor; determine a water flow rate of the cooling water to be conveyed by the water supply system to maintain a difference between the shaft torque and the shaft torque limit within a range; and transmit an output signal indicative of the water flow rate to the water supply system.

### Embodiment 31

The system defined in any proceeding embodiment, wherein the water supply system comprises at least one of a pump, or a control valve, or any combination thereof.

### Embodiment 32

The system defined in any proceeding embodiment, wherein the one or more processing devices are configured to execute the one or more sets of instructions to adjust a property of the cooling water using the water injection system, wherein the property comprises at least one of a temperature, a flow rate, a pressure, a droplet size, or a composition, or any combination thereof.

### Embodiment 33

The system defined in any proceeding embodiment, wherein the one or more processing devices are configured to execute the one or more sets of instructions to adjust the property of the cooling to at least one of increase a mass flow rate available to the compressor, decrease power used to drive the compressor, decrease work used to drive the compressor, increase an efficiency of the compressor, or maintain a difference between a shaft torque of the compressor and a shaft torque limit of the compressor within a range, or any combination thereof.

### Embodiment 34

A method, comprising: compressing a gaseous stream using a compressor; cooling an exhaust gas from combustion with a cooling water using an exhaust gas cooler; and injecting the cooling water from the exhaust gas cooler into at least one of a compressor inlet of the compressor, a stage of the compressor, between stages of the compressor, or an inlet duct coupled to the compressor inlet of the compressor, or any combination thereof, using a water injection system.

### Embodiment 35

The method or system defined in any proceeding embodiment, comprising: receiving an input signal indicative of a property of the gaseous stream; determining a shaft torque of the compressor based at least on the input signal; comparing the shaft torque with a shaft torque limit of the compressor; determining a water flow rate of the cooling water to be injected by the water injection system to maintain a difference between the shaft torque and the shaft torque limit within a range; and transmitting an output signal indicative of the water flow rate to the water injection system.

### Embodiment 36

The method or system defined in any proceeding embodiment, wherein the property of the gaseous stream comprises at least one of a temperature, a pressure, a flow rate, or a composition, or any combination thereof.

### Embodiment 37

The method or system defined in any proceeding embodiment, wherein the compressor comprises an oxidant compressor configured to compress an oxidant to produce a compressed oxidant or an exhaust gas compressor configured to compress the exhaust gas to produce a compressed exhaust gas.

### Embodiment 38

The method or system defined in any proceeding embodiment, wherein the water injection system comprises at least one of a wet compression injection system, or inlet fogging injection system, or any combination thereof.

### Embodiment 39

The method or system defined in any proceeding embodiment, comprising: receiving an input signal indicative of the flow rate of the cooling water; determining an angle of a plurality of inlet guide vanes disposed at the inlet of the compressor based at least in part on the flow rate of the cooling water; and transmitting an output signal indicative of the angle to the plurality of inlet guide vanes.

### Embodiment 40

The method or system defined in any proceeding embodiment, comprising: receiving an input signal indicative of a property of the gaseous stream; determining a shaft torque of the compressor based at least on the input signal; comparing the shaft torque with a shaft torque limit of the compressor; determining a water flow rate of the cooling water to be conveyed by a water supply system configured to convey the cooling water to the exhaust gas cooler, or from the exhaust gas cooler to the water injection system, or any combination thereof, to maintain a difference between the shaft torque and the shaft torque limit within a range; and transmitting an output signal indicative of the water flow rate to the water supply system.

### Embodiment 41

The method or system defined in any proceeding embodiment, comprising adjusting a property of the cooling water using the water injection system, wherein the property comprises at least one of a temperature, a flow rate, a pressure, a droplet size, or a composition, or any combination thereof.

### Embodiment 42

The method or system defined in any proceeding embodiment, comprising adjusting the property of the cooling water to at least one of increase a mass flow rate available to the compressor, decrease power used to drive the compressor, decrease work used to drive the compressor, increase an efficiency of the compressor, or maintain a difference between a shaft torque of the compressor and a shaft torque limit of the compressor within a range, or any combination thereof.

### Embodiment 43

A system, comprising: a water supply system comprising at least one of a heat recovery steam generator (HRSG) configured to generate steam from an exhaust gas, an exhaust gas (EG) processing system configured to receive and process the exhaust gas, or a stoichiometric exhaust gas recirculation (SEGR) gas turbine system configured to stoichiometrically combust a fuel and an oxidant to generate the exhaust gas, or any combination thereof and a water injection system configured to inject a cooling water from the water supply system into at least one of a compressor inlet of a compressor, a stage of the compressor, between stages of the compressor, or an inlet duct coupled to the compressor inlet of the compressor, or any combination thereof.

### Embodiment 44

The method or system defined in any proceeding embodiment, comprising an exhaust gas cooler configured to cool the exhaust gas with the cooling water, wherein the exhaust gas cooler is disposed between the water supply system and the water injection system.

### Embodiment 45

The method or system defined in any proceeding embodiment, comprising the compressor configured to compress a gaseous stream.

### Embodiment 46

The method or system defined in any proceeding embodiment, comprising a plurality of inlet guide vanes disposed at the inlet of the compressor, wherein the plurality of inlet guide vanes are configured to be adjusted in response to a flow rate of the cooling water injected by the water injection system.

### Embodiment 47

The method or system defined in any proceeding embodiment, wherein the water injection system comprises a plurality of injectors disposed at least adjacent a duct inlet of the inlet duct, adjacent the compressor inlet, adjacent a duct outlet of the inlet duct, upstream of a silencer disposed in the inlet duct, or downstream of the silencer, or any combination thereof.

### Embodiment 48

The method or system defined in any proceeding embodiment, wherein the water injection system comprises at least one of a wet compression injection system, or inlet fogging injection system, or any combination thereof.

### Embodiment 49

The method or system defined in any proceeding embodiment, wherein the water supply system comprises at least one of a pump, or a control valve, or any combination thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a compressor configured to compress a gaseous stream;
an exhaust gas cooler configured to cool an exhaust gas from combustion with a cooling water; and
a water injection system configured to inject the cooling water from the exhaust gas cooler into at least one of a compressor inlet of the compressor, a stage of the compressor, between stages of the compressor, or an inlet duct coupled to the compressor inlet of the compressor, or any combination thereof.

2. The system of claim 1, comprising the inlet duct configured to convey the gaseous stream to the inlet of the compressor.

3. The system of claim 1, wherein the compressor comprises an oxidant compressor configured to compress an oxidant to produce a compressed oxidant.

4. The system of claim 3, comprising:
a gas turbine engine, comprising:
a combustor section having one or more combustors configured to generate combustion products by combusting a fuel with the compressed oxidant, wherein the exhaust gas comprises the combustion products, and the exhaust gas cooler is configured to cool the combustion products; and
a turbine section having one or more turbine stages, wherein the one or more turbine stages are driven by the combustion products.

5. The system of claim 4, comprising an exhaust gas extraction system coupled to the gas turbine engine, and a hydrocarbon production system coupled to the exhaust gas extraction system

6. The system of claim 5, wherein the gas turbine engine is a stoichiometric exhaust gas recirculation (SEGR) gas turbine engine

7. The system of claim 1, wherein the compressor comprises an exhaust gas compressor configured to compress the exhaust gas to produce a compressed exhaust gas.

8. The system of claim 7, comprising:
a gas turbine engine, comprising:
a combustor section having one or more combustors configured to generate combustion products by combusting a fuel with an oxidant, wherein the exhaust gas comprises the combustion products, and the exhaust gas cooler is configured to cool the combustion products; and
a turbine section having one or more turbine stages, wherein the one or more turbine stages are driven by the combustion products, wherein the exhaust gas compressor is driven by the turbine section and is configured to route the compressed exhaust gas to the combustor section.

9. The system of claim 1, wherein the water injection system comprises a plurality of injectors disposed at least adjacent a duct inlet of the inlet duct, adjacent the compressor inlet, adjacent a duct outlet of the inlet duct, upstream of a silencer disposed in the inlet duct, or downstream of the silencer, or any combination thereof.

10. The system of claim 1, wherein the water injection system comprises at least one of a wet compression injection system, or an inlet fogging injection system, or any combination thereof.

11. The system of claim 1, comprising a plurality of inlet guide vanes disposed at the inlet of the compressor, wherein the plurality of inlet guide vanes are configured to be adjusted in response to a flow rate of the cooling water injected by the water injection system.

12. The system of claim 1, comprising a water cooler configured to cool the cooling water from the exhaust gas cooler prior to injection by the water injection system.

13. A method, comprising:
compressing a gaseous stream using a compressor;
cooling an exhaust gas from combustion with a cooling water using an exhaust gas cooler; and
using a water injection system to inject the cooling water from the exhaust gas cooler into at least one of a compressor inlet of the compressor, a stage of the compressor, between stages of the compressor, or an inlet duct coupled to the compressor inlet of the compressor, or any combination thereof, using a water injection system.

14. The method of claim 13, comprising:
receiving an input signal indicative of a property of the gaseous stream;
determining a shaft torque of the compressor based at least on the input signal;
comparing the shaft torque with a shaft torque limit of the compressor;
determining a water flow rate of the cooling water to be injected by the water injection system to maintain a difference between the shaft torque and the shaft torque limit within a range; and
transmitting an output signal indicative of the water flow rate to the water injection system.

15. The method of claim 14, wherein the property of the gaseous stream comprises at least one of a temperature, a pressure, a flow rate, or a composition, or any combination thereof.

16. The method of claim 13, comprising:
receiving an input signal indicative of the flow rate of the cooling water;
determining an angle of a plurality of inlet guide vanes disposed at the inlet of the compressor based at least in part on the flow rate of the cooling water; and
transmitting an output signal indicative of the angle to the plurality of inlet guide vanes.

17. The method of claim 13, comprising:
receiving an input signal indicative of a property of the gaseous stream;
determining a shaft torque of the compressor based at least on the input signal;
comparing the shaft torque with a shaft torque limit of the compressor;
determining a water flow rate of the cooling water to be conveyed by a water supply system configured to convey the cooling water to the exhaust gas cooler, or from the exhaust gas cooler to the water injection system, or any combination thereof, to maintain a difference between the shaft torque and the shaft torque limit within a range; and
transmitting an output signal indicative of the water flow rate to the water supply system.

18. The method of claim 13, comprising adjusting a property of the cooling water using the water injection system, wherein the property comprises at least one of a temperature, a flow rate, a pressure, a droplet size, or a composition, or any combination thereof.

19. A system, comprising:
a water supply system comprising at least one of a heat recovery steam generator (HRSG) configured to generate steam from an exhaust gas, an exhaust gas (EG) processing system configured to receive and process the exhaust gas, or a stoichiometric exhaust gas recirculation (SEGR) gas turbine system configured to stoichiometrically combust a fuel and an oxidant to generate the exhaust gas, or any combination thereof; and
a water injection system configured to inject a cooling water from the water supply system into at least one of a compressor inlet of a compressor, a stage of the compressor, between stages of the compressor, or an inlet duct coupled to the compressor inlet of the compressor, or any combination thereof.

20. The system of claim 19, comprising an exhaust gas cooler configured to cool the exhaust gas with the cooling water, wherein the exhaust gas cooler is disposed between the water supply system and the water injection system.
